(19) United States
(12) Patent Application Publication
(10) Pub. No.: US 2019/0289950 A1
(43) Pub. Date: Sep. 26, 2019

(54) INFORMATION PROCESSING METHOD

(71) Applicant: HONDA MOTOR CO., LTD., Tokyo (JP)

(72) Inventors: Tetsuya Matsumoto, Wako-shi (JP); Toshihiro Yamaguchi, Wako-shi (JP); Kazuyuki Kosei, Wako-shi (JP); Kota Yamanaka, Wako-shi (JP); Hiroshi Kimura, Wako-shi (JP); Hiroki Yoshino, Wako-shi (JP); Susumu Iwamoto, Tokyo (JP)

(21) Appl. No.: 16/288,318

(22) Filed: Feb. 28, 2019

(30) Foreign Application Priority Data
Mar. 23, 2018 (JP) 2018-056974

(51) Int. Cl. A43B 3/00; G06Q 30/02; G06Q 20/40; G06F 9/54

(52) U.S. Cl. CPC A43B 3/0005; G06Q 30/0236; G06Q 30/0222; G06F 9/542; G06Q 20/40145

(57) ABSTRACT

an information processing method in which an electronic device embedded in footwear or attached to the footwear. The footwear having a communicator configured to communicate with one or more external terminals executes an authentication step of authenticating, whether or not a user wearing the footwear is an authorized user, an acquisition step of acquiring at least a payment request of a reward for the user wearing the footwear from the one or more external terminals via the communicator when the authentication has succeeded, an acceptance step of accepting the acquired payment request in accordance with a prescribed action performed by the user, and a transmission step of transmitting an acceptance result to the one or more external terminals via the communicator.

### CROSS-REFERENCE TO RELATED APPLICATION

Priority is claimed on Japanese Patent Application No. 2018-056974, filed Mar. 23, 2018, the content of which is incorporated herein by reference.

### BACKGROUND

### Field

The following embodiments relates to an information processing method.

### Description of Related Art

Conventionally, an apparatus for acquiring biological information from a sensor embedded in footwear, a system for identifying a passerby wearing footwear when an integrated circuit (IC) tag embedded in the footwear communicates with a communicator provided at an entrance, and the like have been disclosed (Japanese Unexamined Patent Application, First Publication Nos. 2005-144106, 2005-242959, and 2015-222486).

However, a user's inconvenience could not be sufficiently eliminated in some cases even when a conventional apparatus or system is used. For example, when the user performs an economic activity such as shopping, he/she feels an inconvenience.

### SUMMARY

An aspect of the embodiments has been made in consideration of such circumstances and an objective of the aspect of the embodiments is to provide an information processing method that allow a user to perform economic activities more comfortably.

(1): According to an aspect of the embodiments, there is provided an information processing method in which an electronic device embedded in footwear or attached to the footwear and having a communicator configured to communicate with one or more external terminals executes: an authentication step of authenticating whether or not a user wearing the footwear is an authorized user; an acquisition step of acquiring at least a payment request of a reward for the user wearing the footwear from the one or more external terminals via the communicator when the authentication has succeeded; an acceptance step of accepting the acquired payment request in accordance with a prescribed action performed by the user; and a transmission step of transmitting an acceptance result to the one or more external terminals via the communicator.

(2): In the above-described aspect (1), the prescribed action of the user is movement of the user to a prescribed position.

(3): In the above-described aspect (1), the electronic device is configured to determine that the acquired payment request has been accepted when the user has performed the prescribed action in the acceptance step.

(4): In the above-described aspect (3), the electronic device is configured to transmit payment related information to a terminal apparatus, which is capable of being visually recognized by the user, after processing of the transmission step.

(5): In the above-described aspect (1), the electronic device is configured to further execute a notification step of issuing a notification indicating that the acceptance has been made to an informant provided in the footwear after the acceptance for the payment request is made.

(6): In the above-described aspect (5), the informant is a conductive actuator that contracts with electric current application or a change in temperature due to electric current application and the electronic device is configured to issue the notification by delivering a tactile change to a foot of the user in contact with the footwear by operating the actuator in the notification step.

(7): In the above-described aspect (1), after the user is authenticated to be the authorized user in the authentication step, the electronic device is configured to cancel the authentication when the user removes the footwear or when a prescribed time has elapsed after the removal.

(8): In the above-described aspect (1), the electronic device is configured to detect vibration occurring in the footwear and the electronic device is configured to control some or all of electronic functions provided in the footwear in an OFF state when vibration of a prescribed level or more has not been detected.

(9): In the above-described aspect (1), the footwear or the electronic device for which the user has been authenticated to be the authorized user in the authentication step is configured to radiate light including identification information and a management apparatus is configured to acquire the identification information included in the radiated light and make a prescribed determination on the basis of the acquired identification information included in the light.

(10): In the above-described aspect (1), an electromagnet is provided in the footwear and the electronic device is configured to control the electromagnet in an ON state on the basis of a result of authenticating whether or not the user is the authorized user in the authentication step or on the basis of information transmitted by an external terminal.

(11): In the above-described aspect (1), the electronic device is configured to limit some or all of electronic functions executable by the footwear on the basis of an operation of an operator provided in the footwear performed by the user or on the basis of an instruction from an external terminal.

(12): In the above-described aspect (1), the electronic device is configured to detect movement in a state in which the footwear has been lifted above the ground and detect a movement form of the footwear and cause a function according to a detection result to be activated or enabled on the basis of a detection result.

(13): According to another aspect of the embodiments, there is provided an information processing method including: transmitting, by an electronic device embedded in first footwear or attached to the first footwear and having a communicator configured to communicate with an external terminal, first information for accepting a payment request to a management apparatus; transmitting, by an electronic device embedded in second footwear or attached to the second footwear and having a communicator configured to communicate with an external terminal, second information for accepting a payment request to the management apparatus; and determining, by the management apparatus, whether or not to execute a prescribed process on the basis of the first information and the second information.

(14): In the above-described aspect (13), the management apparatus is configured to notify a user of information indicating that the prescribed process is not being executed if the management apparatus determine not to execute the prescribed process.

(15): In the above-described aspect (13), the management apparatus is configured to determine whether or not to execute the prescribed process on the basis of information acquired from another apparatus if management apparatus determine not to execute the prescribed process.

(16): In the above-described aspect (13), the management apparatus is configured to determine whether or not to execute a process different from the prescribed process on the basis of the first information without using the second information.

(17): According to still another aspect of the embodiments, there is provided an information processing method including: determining, by a management apparatus, which acquires first information transmitted by an electronic device embedded in first footwear or attached to the first footwear and having a communicator configured to communicate with an external terminal or second information transmitted by an electronic device embedded in second footwear or attached to the second footwear and having a communicator configured to communicate with an external terminal, whether or not to execute a prescribed process on the basis of the second information when communication with the first footwear is not possible or when acquisition of the first information is not possible.

(18): In the above-described aspect (13), the first footwear is footwear for a right foot and the second footwear is footwear for a left foot or the first footwear is footwear for a left foot and the second footwear is footwear for a right foot.

(19): In the above-described aspect (13), the prescribed process is a process on payment of a reward.

According to the above-described aspects (1), (18), and (19), the user can perform economic activities more comfortably. For example, the user can perform payment and the like without taking out a terminal apparatus, a card, or the like for economic activities.

According to the above-described aspect (2), the user can perform payment or the like without performing a cumbersome action.

According to the above-described aspects (3) and (11), it is possible to limit a process unintended by the user.

According to the above-described aspect (4), because the user can check payment related information, the reliability of a system is improved.

According to the above-described aspect (5), because the user can recognize that a payment related process has been performed, the reliability of a system is improved.

According to the above-described aspect (6), because it can be tactually recognized that a payment related process has been performed, visual work can be reduced and the user's convenience is improved.

According to the above-described aspects (7) and (10), security can be improved.

According to the above-described aspect (8), because it is possible to limit the continuation of an operating state of an electronic function in a situation in which the electronic function is unnecessary, power consumption can be limited.

According to the above-described aspect (9), it is possible to implement authentication of a plurality of users, a plurality of processes, and the like with a low cost.

According to the above-described aspect (12), because a function can be activated or enabled by a gesture of a foot or the like, the user's convenience is further improved.

According to the above-described aspect (13), for example, because a prescribed process, such as payment, is executed on the basis of information transmitted by footwear of both feet, it is possible to limit the execution of a process unintended by the user.

According to the above-described aspect (14), because a notification indicating that a prescribed process is not performed is provided, the user can recognize that an abnormality has occurred in footwear and the reliability of a system is improved.

According to the above-described aspect (15), because a prescribed process such as payment can be executed using another apparatus, the reliability of a system can be improved.

According to the above-described aspect (16), because whether or not to use information transmitted by footwear of both feet is variable in accordance with a process, the user's convenience is improved. For example, even when there is an abnormality in one piece of footwear, a process different from a prescribed process is executed.

According to the above-described aspect (17), because a prescribed process is executed according to information transmitted from one of two pieces of footwear, the user's convenience is improved. For example, even when one piece of footwear has an abnormality, a prescribed process is executed.

### BRIEF DESCRIPTION OF THE DRAWINGS

FIG. 1 is a configuration diagram of an information processing system using an information processing method or an electronic device according to an embodiment.

FIG. 2 is a schematic view of footwear.

FIG. 3 is a diagram showing an example of a functional configuration mounted on the footwear.

FIG. 4 is a diagram showing an example of a functional configuration of a management apparatus.

FIG. 5 is a diagram showing an example of an entrance of a shop.

FIG. 6 is a diagram showing an example of an internal appearance of a shop.

FIG. 7 is a flowchart showing an example of a flow of a process to be executed by footwear.

FIG. 8 is a diagram showing information indicating a detection value included in authentication information.

FIG. 9 is a flowchart (1) showing an example of a flow of a process to be executed by a management apparatus.

FIG. 10 is a diagram showing a process of generating person information.

FIG. 11 is a flowchart (2) showing an example of a flow of a process to be executed by the management apparatus.

FIG. 12 is a diagram showing an example of details of item information.

FIG. 13 is a diagram showing an example of details of a purchase target list.

FIG. 14 is a flowchart showing an example of a flow of a process to be executed by an information processing system 1 during a period from a timing at which a user enters a shop to a timing at which the user leaves.

FIG. 15 is a diagram showing an example of appearances in which a user has stopped at a first point and a second point.

FIG. 16 is a diagram showing a configuration of an information processing system of a second embodiment.

FIG. 17 is a diagram showing an example of a functional configuration of footwear A.

FIG. 18 is a sequence diagram showing a process to be executed by the information processing system of a third embodiment.

FIG. 19 is a sequence diagram showing a process to be executed by an information processing system according to a modified example of the third embodiment.

FIG. 20 shows an example of a flow of a process to be executed by one or both of pieces of footwear.

FIG. 21 is an example showing a functional configuration of an authentication apparatus.

FIG. 22 is a diagram showing an example of details of user correspondence information.

FIG. 23 is a diagram showing an authentication process to be performed by an authentication apparatus.

FIG. 24 is a diagram showing an example of a hardware configuration of footwear of an embodiment.

### DETAILED DESCRIPTION

Hereinafter, embodiments of an information processing method of the embodiments will be described with reference to the drawings.

### First Embodiment

### [Overall Configuration]

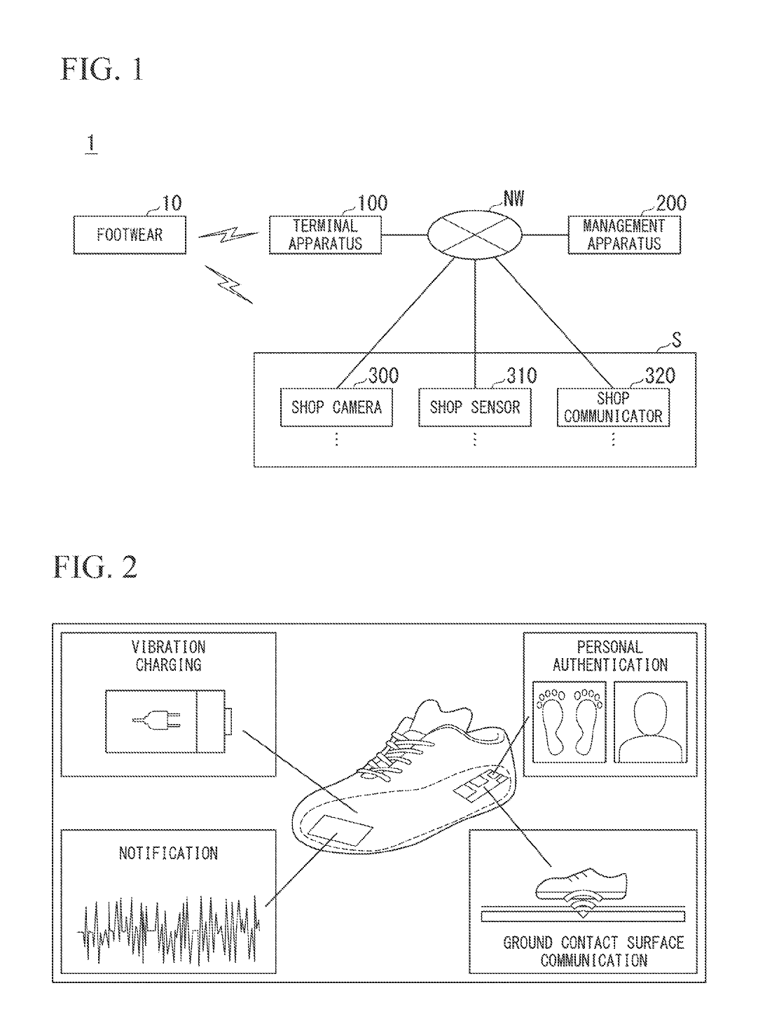

FIG. 1 is a configuration diagram of an information processing system 1 using an information processing method or an electronic device according to an embodiment. The information processing system 1 includes, for example, footwear 10, a terminal apparatus 100, a management apparatus 200, one or more shop cameras 300, one or more shop sensors 310, and one or more shop communicators 320. The shop cameras 300, the shop sensors 310, and the shop communicators 320 are provided, for example, within a shop S. Footwear is, for example, shoes, boots, sandals, slippers, and the like. Hereinafter, the shop camera 300, the shop sensor 310, and the shop communicator 320 will be referred to as “specific facilities” unless distinguished in particular.

The terminal apparatus 100, the management apparatus 200, and the specific facilities communicate with one another, for example, via a network NW. The network NW includes, for example, a wide area network (WAN), a local area network (LAN), the Internet, a dedicated line, a radio base station, a provider, and the like. Also, the footwear 10 and the terminal apparatus 100 communicate with each other using a prescribed communication standard. The prescribed communication standard is a communication standard used for short-range wireless communication such as Bluetooth (registered trademark) or Wi-Fi. The footwear 10 and the terminal apparatus 100 may perform communication via the network NW. Further, the footwear 10 and the shop communicator 320 perform communication within a prescribed distance range.

### [Footwear]

FIG. 2 is a schematic diagram of the footwear 10. For example, the footwear 10 has a function of generating electric power by vibration and performing a charging process with the generated power (a vibration charging function) as will be described below, a function of authenticating a user (a personal authentication function), a function of communicating with a communicator provided on a ground contact surface (or under the ground contact surface) (a ground contact surface communication function), a function of notifying the user of various types of information (a notification function), and the like.

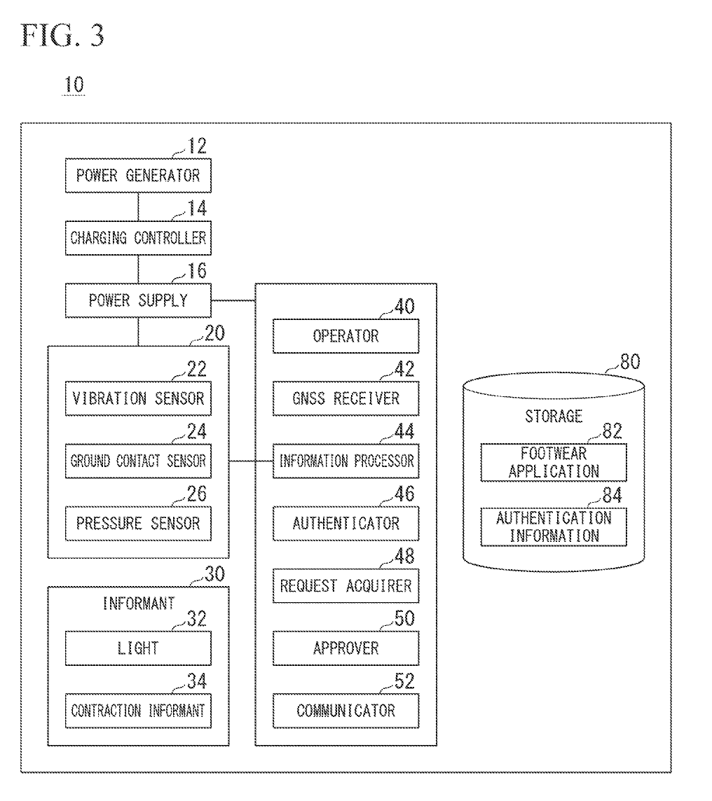

FIG. 3 is a diagram showing an example of a functional configuration mounted on the footwear 10. A part or all of the functional configuration shown in FIG. 2 is an example of an “electronic device” embedded in the footwear or an “electronic device” attached thereto. The footwear 10 includes, for example, a power generator 12, a charging controller 14, a power supply 16, a plurality of sensors 20, and an informant 30.

### [Functional Configuration (Part 1)]

The power generator 12 generates power by vibration or pressure when the user walks or runs in a state in which he/she is wearing the footwear 10. The power generator 12 includes, for example, a piezoelectric element, an electromagnetic induction type power generator, or the like.

The charging controller 14 converts the power generated by the power generator 12 into power of a prescribed voltage value or a prescribed current value and supplies the converted power to the power supply 16. The charging controller 14 may receive power supplied from a power supply connected to a connector (not shown) provided in the footwear 10.

The power supply 16 is, for example, a rechargeable battery that can be repeatedly used. The power supply 16 stores the power supplied by the charging controller 14 or supplies the stored power to each part of the footwear 10. Also, the power supply 16 may be a primary battery. Also, the footwear 10 may have a function in which power is fed in a contactless manner.

The plurality of sensors 20 include, for example, one or more vibration sensors 22, one or more ground contact sensors 24, one or more pressure sensors 26, and the like. The vibration sensor 22 detects vibration of the footwear 10. The ground contact sensor 24 detects a repulsive force received by the bottom of the footwear 10 from a ground contact surface such as the ground. The pressure sensor 26 detects the repulsive force received from the user's foot when the user has worn the footwear 10. The pressure sensor 26 is provided inside the footwear 10 and provided at a position where a sole of the foot touches the pressure sensor 26 when the user has worn the footwear 10. A plurality of pressure sensors 26 are evenly provided at the above-described touch position.

The informant 30 includes, for example, a light 32 and a contraction informant 34. The light 32 is turned on, blinked, and turned off on the basis of control of the information processor 44. The light 32 is provided, for example, on a side surface of the sole of the footwear 10 and the like.

The contraction informant 34 is, for example, an actuator formed of a metallic elongated element that contracts with a change in a current or a change in heat. The contraction informant 34 is provided in an upper portion (a portion that covers an instep of the foot when the user wears the footwear 10), an eyelet (a portion through which a shoelace is passed), or the like. For example, when an element is provided in the upper portion, the element contracts if a current of a prescribed value or more flows through the element. Then, when the element contracts, the upper portion changes to tighten the instep of the foot as compared with a normal state. Thereby, the user of the footwear 10 can recognize a prescribed notification. Also, in addition to the above-described configuration, the informant 30 may include a vibrator that issues a prescribed notification based on vibration, a small speaker that outputs a sound, or the like.

### [Functional Configuration (Part 2)]

Also, the footwear 10 includes, for example, an operator 40, a global navigation satellite system (GNSS) receiver 42, an information processor 44, an authenticator 46, a request acquirer 48, an approver 50, a communicator 52, and a storage 80. For example, each of the information processor 44, the authenticator 46, the request acquirer 48, and the approver 50 are implemented by a hardware processor such as a central processing unit (CPU) executing a program (software). Also, some or all of these components may be implemented by hardware (including circuitry) such as large scale integration (LSI), an application specific integrated circuit (ASIC), a field-programmable gate array (FPGA), a graphics processing unit (GPU), or may be implemented by cooperation of software and hardware. The program is a footwear application program (footwear application) 82 previously stored in the storage 80 of the footwear 10 or installed via the communicator 52.

The storage 80 is implemented by, for example, a nonvolatile storage medium such as a read only memory (ROM), a flash memory, or a secure digital (SD) card and a volatile storage medium such as a random access memory (RAM) or a register. In the storage 80, authentication information 84 (whose details will be described below) is further stored in addition to the above-described footwear application 82.

The operator 40 is a mechanical or electronic switch for turning on or off the electronic function of the footwear 10. The electronic function is, for example, a function to be executed by the GNSS receiver 42, the information processor 44, the authenticator 46, the request acquirer 48, the approver 50, or the communicator 52. The GNSS receiver 42 identifies a position of the footwear 10 on the basis of a signal received from a GNSS satellite and outputs position information indicating the identified position of the footwear 10 to the information processor 44.

The information processor 44 acquires a detection result of the sensor 20 and the position information identified by the GNSS receiver 42 and stores the acquired information in the storage 80 or transmits a processing result of each part to another apparatus.

The authenticator 46 authenticates whether the user wearing the footwear 10 is an authorized user. The request acquirer 48 acquires a payment request of a reward for the user wearing the footwear 10 from the shop communicator 320 (or the management apparatus 200). The approver 50 transmits information indicating acceptance of the payment request acquired by the request acquirer 48 in accordance with a prescribed action performed by the user. The prescribed action is, for example, movement of the user to a prescribed position. Details of the process of the authenticator 46, the request acquirer 48, and the approver 50 will be described below.

The communicator 52 communicates with another apparatus and transmits and receives information. Although the example in which the footwear 10 includes the communicator 52 has been described in the present embodiment, another communicator may be further provided in addition to the communicator 52. The other communicator is, for example, a communicator that performs communication using a communication scheme different from a communication scheme in which the communicator 52 communicates with another apparatus.

### [Terminal Apparatus]

The terminal apparatus 100 is, for example, a smartphone, a tablet terminal, a personal computer, a wearable device (such as a smart watch or a smart glass), or the like. In the terminal apparatus 100, an application program is stored in the storage apparatus of the terminal apparatus 100. This application program cooperates with the function of the footwear application 82 or assists the function of the footwear application 82. For example, the user can turn on the electronic function of the footwear 10 via the terminal apparatus 100 or limit the electronic function of the footwear 10 via the terminal apparatus 100 by operating the operator of the terminal apparatus 100. Also, the terminal apparatus 100 causes a display of the terminal apparatus 100 to display information transmitted from the footwear 10 and information transmitted from the management apparatus 200.

### [Management Apparatus]

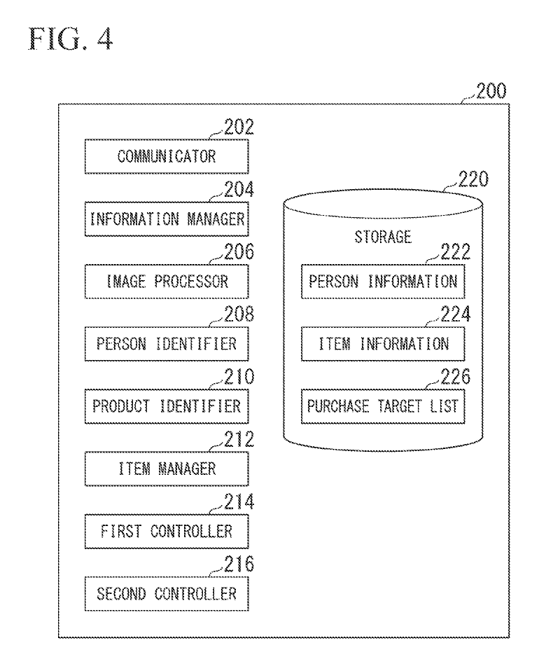

FIG. 4 is a diagram showing an example of a functional configuration of the management apparatus 200. The management apparatus 200 includes, for example, a communicator 202, an information manager 204, an image processor 206, a person identifier 208, a product identifier 210, an item manager 212, a first controller 214, a second controller 216, and a storage 220. Each of the information manager 204, the image processor 206, the person identifier 208, the product identifier 210, the item manager 212, the first controller 214, and the second controller 216 is implemented by a hardware processor such as, for example, a CPU, executing a program (software). Also, some or all of these components may be implemented by hardware (including circuitry) such as LSI, an ASIC, an FPGA, or a GPU or may be implemented by cooperation of software and hardware. The program may be pre-stored in a storage apparatus such as a hard disk drive (HDD) or a flash memory of the management apparatus 200, stored in a detachable storage medium such as a DVD or a CD-ROM, and installed in the HDD or the flash memory of the management apparatus 200 when the storage medium is attached to a drive apparatus. The storage 220 is realized by, for example, a nonvolatile storage medium such as a ROM, a flash memory, an HDD, or an SD card and a volatile storage medium such as a RAM or a register. The storage 220 stores, for example, person information 222, item information 224, and a purchase target list 226 which will be described below. Also, the above-described program or the information stored in the storage 220 may be managed and stored on a cloud or stored and read when necessary. The communicator 202 communicates with the terminal apparatus 100 and the specific facility.

The information manager 204 stores the information acquired by the communicator 202 in the storage 220 or transmits a processing result of its own apparatus to another apparatus (the footwear 10 or the terminal apparatus 100) via the communicator 202.

The image processor 206 recognizes positions, movement states, and the like of a person present in the shop, a product arranged in the shop (or picked up by the user), other objects, and the like on the basis of an image captured by the shop camera 300. For example, the image processor 206 acquires a feature quantity from the acquired image and derives an edge from the acquired feature quantity. Then, the image processor 206 identifies a type of object on the basis of a model of the object held in advance and the derived edge. The edge includes pixels or a pixel group in which a luminance difference or a color parameter difference from a pixel group obtained by grouping nearby pixels or pixels changes to a value greater than a standard. For example, the edge is derived by obtaining a change in a feature quantity from nearby pixels or a pixel group using a Sobel filter or the like. The model of the object is, for example, a distribution of edges defined for each type of object.

On the basis of a processing result of the image processor 206, the person identifier 208 identifies a region where the same person as a person identified by the image processor 206 in a previous process (for example, a process one cycle before) is shown from the image. For example, a distribution of feature quantities (edges) of the person identified in the previous process is stored in the person information 222. The person identifier 208 compares a distribution of feature quantities of the person information 222 with a distribution of feature quantities derived by the image processor 206 and identifies persons having the same distribution of feature quantities as the same person.

On the basis of the processing result of the image processor 206, the product identifier 210 compares a distribution of feature quantities of a product included in the item information 224 with a distribution of feature quantities derived by the image processor 206 and identifies a product having the same distribution of feature quantities as the same product.

For example, the image processor 206, the person identifier 208, and the product identifier 210 may implement a function based on artificial intelligence (AI) and a function based on a previously given model in parallel. For example, a function of “identifying a product” may be implemented by executing recognition of a product by deep learning or the like and recognition based on a prescribed condition (a product for which pattern matching is possible) in parallel and comprehensively evaluating the recognitions by giving scores thereto.

Details of the item manager 212, the first controller 214, and the second controller 216 will be described below. A part or all of the functional configuration of the management apparatus 200 may be provided in the footwear 10.

### [Shop Cameras]

The shop cameras 300 are, for example, digital cameras using a solid-state imaging device such as a charge coupled device (CCD) or a complementary metal oxide semiconductor (CMOS). The shop cameras 300 (for example, several tens to hundreds of cameras) are provided at prescribed intervals inside and outside the shop. For example, the shop cameras 300 image appearances of the inside and outside of the shop such as a user who has entered the shop, a user who has exited the shop, a user in the shop, and a product in the shop.

### [Shop Sensors]

The shop sensors 310 are provided in an entrance or an exit of the shop or at prescribed positions within the shop. The shop sensor 310 is a sensor for detecting a user (an object). The shop sensor 310 is, for example, a photoelectric sensor that detects an object using the property of light.

### [Shop Communicators]

The shop communicators 320 are provided on (a lower side of) a ground contact surface, on which the footwear 10 is grounded at the entrance or exit of the shop, or at a prescribed position in the shop. The shop communicator 320 communicates with the communicator 52 of the footwear 10 when the bottom of the footwear 10 contacts or approaches the ground contact surface on which the shop communicator 320 is provided.

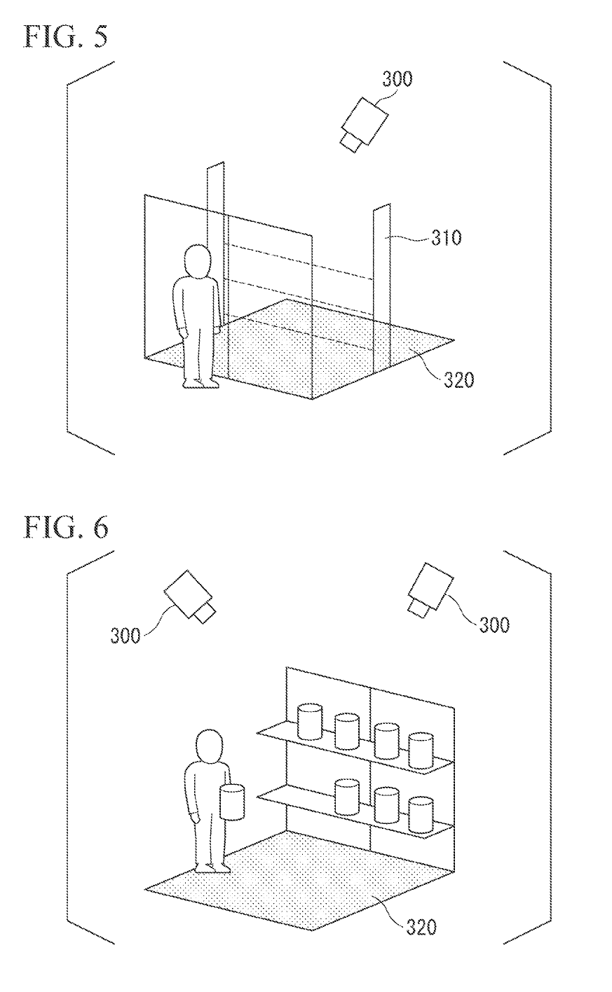

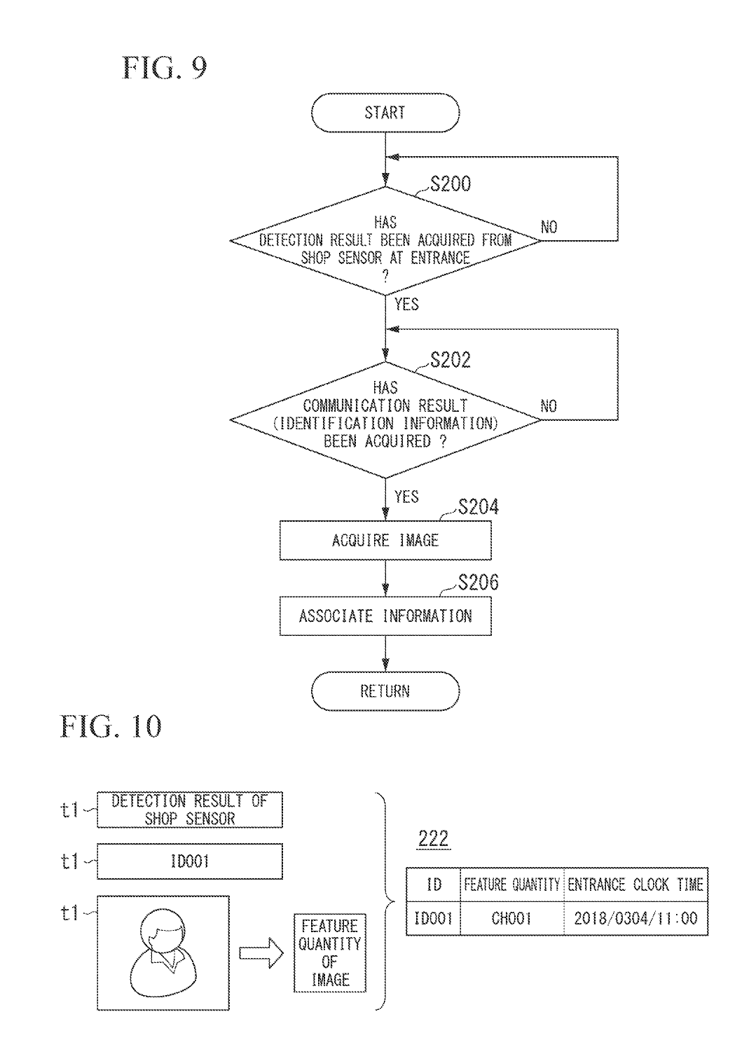

The shop in which the shop cameras, the shop sensors, and the shop communicator are provided will be described. FIG. 5 is a diagram showing an example of the entrance of the shop. For example, in the vicinity of the entrance of the shop, one or more shop cameras 300 are provided at positions where the user who has entered the shop is imaged. Also, one or more shop sensors 310 are provided at positions for detecting users who have entered the shop. Further, in the vicinity of the entrance of the shop, the shop communicator 320 is provided on the ground contact surface with which the user who entered the shop is in contact. In this manner, specific facilities are provided near the entrance (and the exit) of the shop. Then, the management apparatus 200 can identify a user entering the shop (exiting the shop) by analyzing detection results thereof and the like (see FIGS. 9 and 10).

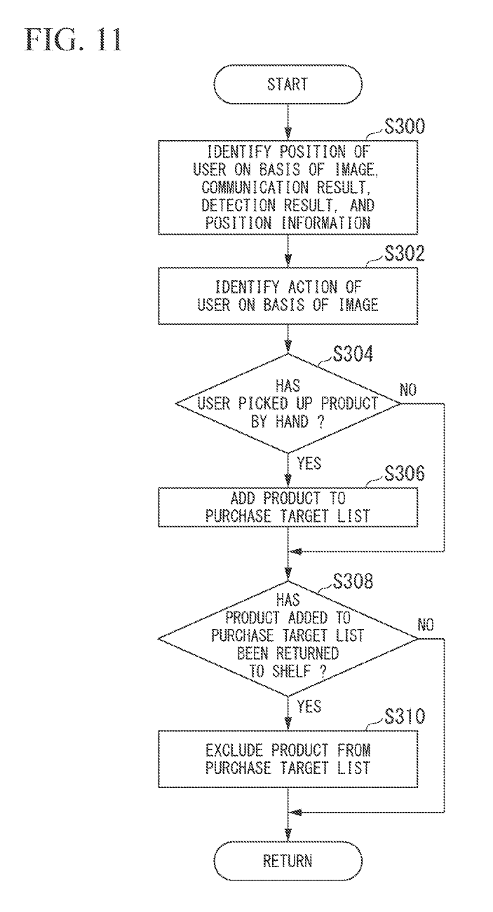

FIG. 6 is a diagram showing an example of an internal appearance of the shop. For example, in the shop, one or more shop cameras 300 are provided at positions where the users present in the shop are imaged. Also, the shop communicator 320 is provided on the ground contact surface with which the user present in the shop is in contact. At least one shop sensor 310 may be provided at a position for detecting the user present in the shop. In this manner, the specific facilities are provided in the shop. Then, the management apparatus 200 can identify an action of the user in the shop by analyzing detection results thereof and the like (see FIGS. 11 to 13).

### [Process to be Executed by Footwear]

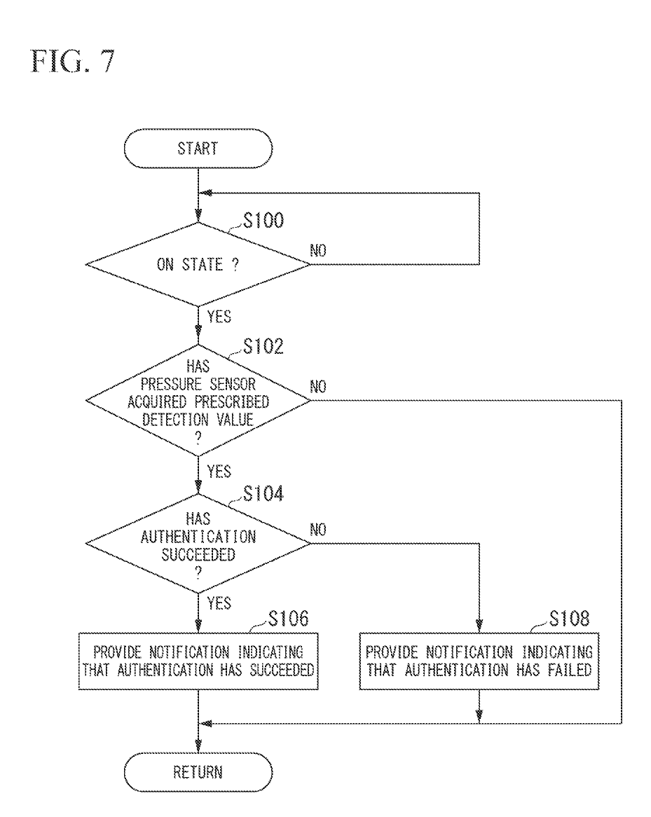

FIG. 7 is a flowchart showing an example of a flow of a process to be executed by the footwear 10. First, in the footwear 10, it is determined whether or not the footwear 10 is in an ON state (step S100) by operating the operator 40 of the footwear 10 in the ON state. When the footwear 10 is in the ON state, the information processor 44 determines whether or not a prescribed detection value has been acquired from the pressure sensor 26 (step S102). The prescribed detection value is, for example, a detection value greater than or equal to a threshold value. When the prescribed detection value has not been detected, a process of one routine of the present flowchart ends.

When the prescribed detection value has been detected, the authenticator 46 compares a distribution of detection values of the pressure sensor 26 with a preset distribution of detection values included in the authentication information 84 and determines whether or not the detection values match (step S104). The matching is not limited to a perfect matching but includes a case in which a degree of matching is greater than or equal to a prescribed degree. A determination of whether or not the detection values match is, in other words, a “determination of whether or not authentication has succeeded”.

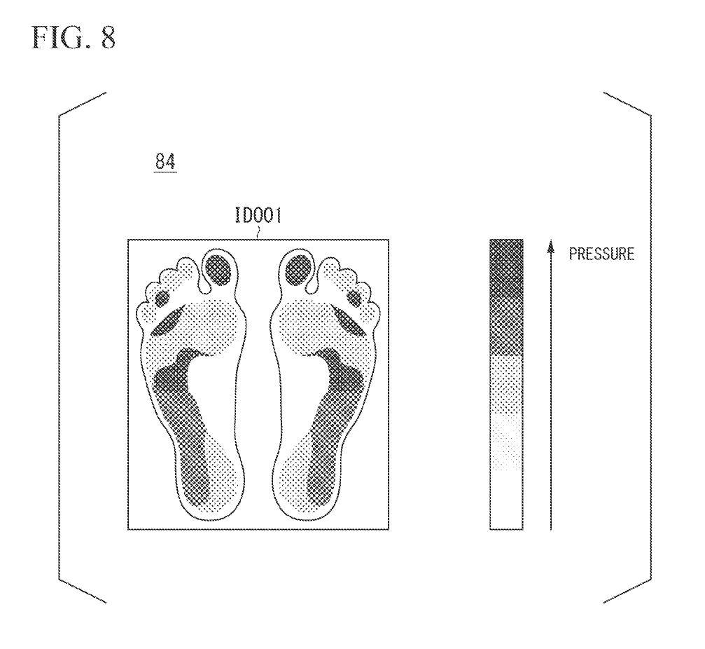

FIG. 8 is a diagram showing information indicating detection values included in the authentication information 84. For example, the authentication information 84 is information in which a degree of pressure is associated with each region as shown. For example, when the user wears the footwear 10 and performs a prescribed operation, the footwear 10 stores the distribution of pressures when the user wears the footwear 10. The prescribed operation is an operation on the operator 40 or an operation on the terminal apparatus 100. For example, for one piece of footwear 10 (or a pair of footwear 10), a distribution of pressures for only one user may be stored or a distribution of pressures of a plurality of users may be stored. When the distribution of pressures of a plurality of users is stored for the footwear 10, for example, identification information of a user is set by operating the terminal apparatus 100 and a distribution of pressures detected after the setting (or at the time of the setting) is stored as a distribution of pressures of the user in the authentication information 84. After the terminal apparatus 100 is operated by the user and the identification information is input by the user, the footwear 10 determines whether or not authentication has succeeded by comparing a distribution of pressures associated with the input identification information with a detected distribution of pressures.

When the authentication has succeeded, the authenticator 46 notifies the user of information indicating that the authentication has succeeded (step S106). The notification to the user includes a notification to the informant 30 and a notification to the terminal apparatus 100 of the user. Step S106 is an example of an “authentication step”.

When the authentication has failed, the authenticator 46 notifies the user of information indicating that the authentication has failed (step S108). Thereby, the process of one routine of the present flowchart ends.

According to the above-described process, the footwear 10 can easily determine whether or not the user wearing the footwear 10 is an authorized user. Although the example in which the user is authenticated by detecting the pressure has been described above, the terminal apparatus 100 may transmit information indicating that the authentication has succeeded to the footwear 10 when a preset password has been input to the terminal apparatus 100 and the footwear 10 may cause the authentication to succeed in accordance with acquisition of the transmitted information in place of the example or in addition to the example. Also, it may be determined whether or not authentication has succeeded on the basis of a contact state between the footwear 10 and the foot of the user, a manner of walking when the user walks a predetermined number of steps after wearing the footwear, a manner in which the user wears shoes of the user, and the like as well as the above-described pressure on the sole of the foot.

[Process to be Executed when User Enters Shop]

FIG. 9 is a flowchart (1) showing an example of a flow of a process to be executed by the management apparatus 200. First, the information manager 204 determines whether or not a detection result has been acquired from the shop sensor 310 installed at the entrance of the shop (step S200). When the detection result has been acquired from the shop sensor 310, the information manager 204 determines whether or not a communication result has been acquired from the shop communicator 320 (step S202). When the communication result has been acquired from the shop communicator 320, the information manager 204 acquires an image captured by the shop camera 300 (step S204).

Next, the information manager 204 generates person information 222 which is information wherein information acquired in the above-described process and a clock time at which the information has been acquired are associated (step S206). When the detection result of the shop sensor 310, the communication result of the shop communicator 320, and the image captured by the shop camera 300 have been acquired within a prescribed time, the information manager 204 associates the information acquired within the prescribed time with the clock time and defines the information associated with the clock time as the person information 222. Thereby, the process of one routine of the present flowchart ends.

FIG. 10 is a diagram showing a process of generating the person information 222. The person information 222 is information in which a detection result from the shop sensor, a result of performing communication between the shop communicator 320 and the footwear 10, a result of processing an image captured by the shop camera 300 (e.g., a feature quantity), and a clock time are associated with one another. In this manner, it is possible to identify a user entering the shop and a clock time at which the user has entered the shop by generating the person information 222. Details of the person information 222, the captured image, and the like may be displayed on a display provided near the entrance of the shop. Thereby, the user can check whether the user has been correctly recognized.

According to the above-described process, the management apparatus 200 can easily identify a person entering the shop and track the person after the person enters the shop. In place of (or in addition to) the above-described process, the position information of the footwear 10 may be used in determining whether or not the person has entered the shop.

[Process to be Executed after User Enters Shop]

FIG. 11 is a flowchart (2) showing an example of a flow of a process to be executed by the management apparatus 200. First, the information manager 204 acquires an image captured by the shop camera 300, a detection result of the shop sensor 310, a communication result of the shop communicator 320, and position information acquired from the footwear 10, and identifies a position of the user on the basis of acquired information (step S300). That is, when the user has entered a shop, the position of the user present within the shop is tracked.

Next, the image processor 206 analyzes the image captured by the shop camera 300 and identifies an action of the user (step S302). The action of the user is, for example, an action in which the user is moving, an action in which the user is trying to pick up a product by hand, an action in which the user has picked up a product by hand, an action in which a product picked up by the user's hand has been returned to a shelf, or an action in which the user has returned a product placed in a bag or the like to a shelf, or the like.

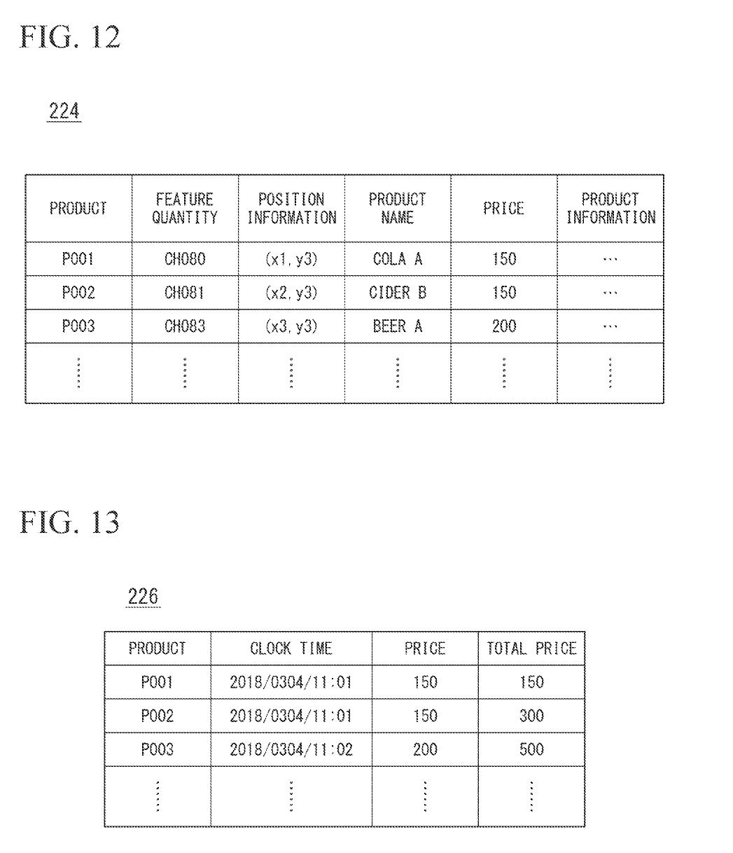

Also, the product identifier 210 refers to the item information 224 and identifies a product picked up by the user's hand or a product picked up once by the user's hand and returned to a shelf. FIG. 12 is a diagram showing an example of details of the item information 224. The item information 224 is information in which a feature quantity of a product, information about a position where the product is placed normally (information indicating a shelf and a position of a shelf where the product is placed), a product name, a product price, and product information (information indicating details of the product) are associated with identification information of the product. The feature quantity of the product is information indicating a feature of the product derived from a processing result of the image processor 206.

The product identifier 210 identifies the product on the basis of the feature quantity of the product picked up by the user's hand and position information of the product picked up by the user's hand. For example, even when a position where the product is placed is different from a normal position, the product picked up by the user's hand is identified to be a product having a feature quantity in the item information 224 that has been compared if a degree of matching between the feature quantity included in the item information 224 and the feature quantity derived by the image processor 206 is greater than or equal to a first threshold value.

Also, for example, when the position where the product is placed is the normal position and the degree of matching between the feature quantity included in the item information 224 and the feature quantity derived by the image processor 206 is greater than or equal to a second threshold value (<the first threshold value), the product picked up by the user's hand is identified to be a product having a feature quantity that has been compared.

Also, for example, when the degree of matching between the feature quantity included in the item information 224 and the feature quantity derived by the image processor 206 is greater than or equal to a third threshold value and the product having the feature quantity derived by the image processor 206 is a product that was placed in a bag or the like by the user or held by the user's hand in the past, the product is determined to be a product having a feature quantity included in the item information 224 for which the degree of matching is determined to be greater than or equal to the third threshold value. The third threshold value may be the same as the first threshold value or the second threshold value, or may be a small value.

Returning to a description of FIG. 11, the image processor 206 determines whether or not the user has picked up a product by hand (step S304). When the user has not picked up the product by hand, the process proceeds to step S308.

When the user picks up the product by hand, the item manager 212 adds information of the product that the user has picked up by hand (or placed in a bag or the like) to a purchase target list 226 (step S306). FIG. 13 is a diagram showing an example of details of the purchase target list 226. The purchase target list 226 is information indicating a list of products set as purchase candidates by the user. For example, the products set as the purchase candidates are a list of products placed by the user in a bag or the like. The purchase target list 226 is information in which information such as a product name, a price, and a total of prices is associated with product identification information.

Next, the image processor 206 determines whether or not a product added to the purchase target list 226 has been returned to a shelf (step S308). When the product added to the purchase target list 226 has not been returned to the shelf, the process of one routine of the present flowchart ends. When the product added to the purchase target list 226 has been returned to the shelf, the item manager 212 excludes the product returned to the shelf from the purchase target list 226 (step S310). Thereby, the process of one routine of the present flowchart ends.

According to the above-described process, a product that the user has tried to purchase is automatically managed. As a result, it becomes unnecessary for the user or staff to manage the product that the user has tried to purchase and convenience is improved.

[Process to be Executed when User Exits Shop]

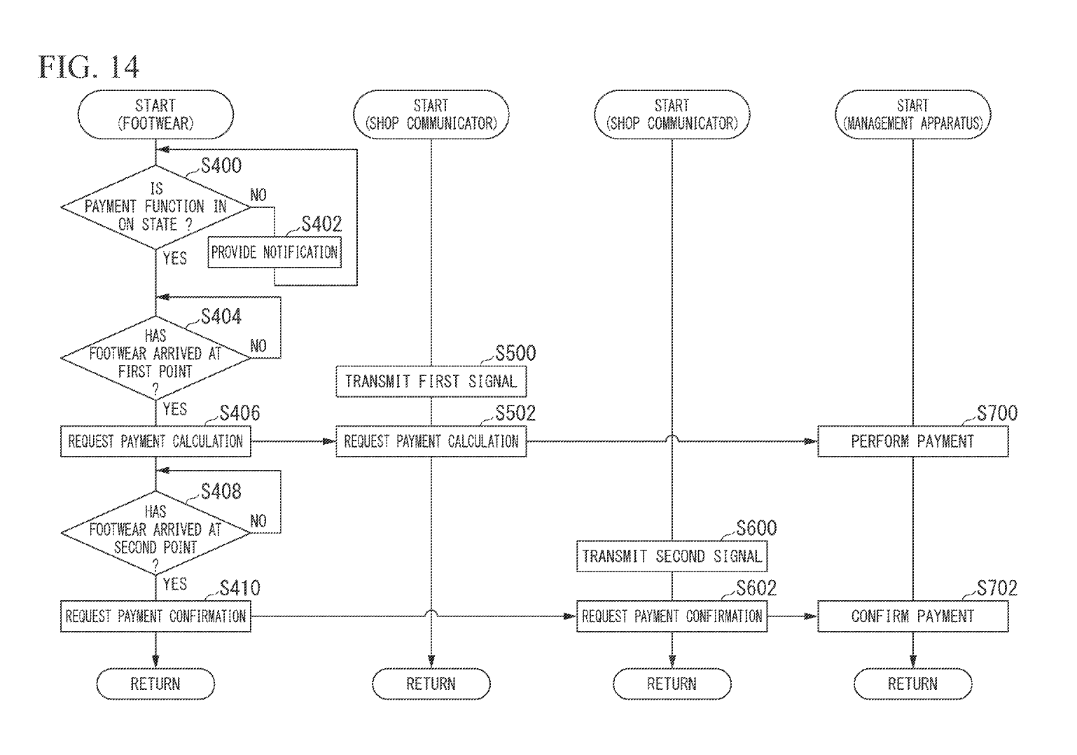

FIG. 14 is a flowchart showing an example of a flow of a process to be executed by the information processing system 1 during a period from a timing at which a user enters a shop to a timing at which the user exits the shop. First, the footwear 10 determines whether or not a payment function is in an ON state (step S400). When the user performs a prescribed operation on the operator 40 of the footwear 10 or performs a prescribed operation by operating the terminal apparatus 100, the payment function transits to the ON state. An operation in which the payment function is executed in the ON state may be performed before the user enters the shop or may be performed after the user enters the shop.

If the payment function is not in the ON state, the footwear 10 notifies the user that the payment function is not in the ON state (step S402). For example, the notification is performed by the footwear 10 controlling the informant 30 on the basis of an instruction from the terminal apparatus 100 or the management apparatus 200. For example, the terminal apparatus 100 or the management apparatus 200 acquires position information from the footwear 10 and determines whether or not the payment function of the footwear 10 in the shop is in the ON state on the basis of the position information and the information indicating the state of the footwear 10 acquired from the footwear 10.

When the payment function is in the ON state, the request acquirer 48 determines whether or not the user has arrived at a first point (step S404). The first point is, for example, a preset point and is a point at which the user stops when a payment for purchasing a product included in the purchase target list 226 is calculated.

For example, the shop communicator 320 (EN) is provided at the first point. The shop communicator 320 (EN) transmits a first signal (step S500). When the user has arrived at the first point, the footwear 10 receives the first signal. That is, the request acquirer 48 acquires at least a payment request from an external terminal.

When the first signal is received, the request acquirer 48 transmits payment calculation request information for requesting payment calculation to the shop communicator 320 (EN) (step S406). The payment calculation request information is information including a user ID. When the payment calculation request information is acquired, the shop communicator 320 (EN) transmits the acquired payment calculation request information to the management apparatus 200 (step S502). The first controller 214 of the management apparatus 200 calculates a payment for the products included in the purchase target list 226 (step S700). For example, the first controller 214 calculates the payment by summing prices of products included in the purchase target list 226.

Next, the approver 50 determines whether or not the user has arrived at a second point (step S408). The second point is, for example, a preset point and is a point at which the user stops when settlement is performed on the products for which the amount of payment has been calculated. For example, the shop communicator 320 (EX) is provided at the second point. The shop communicator 320 (EX) transmits a second signal (step S600). When the user has arrived at the second point, the footwear 10 receives the second signal. When the second signal is received, the approver 50 transmits payment request information for requesting payment confirmation (settlement) to the shop communicator 320 (EX) (step S410). The payment request information is information including a user ID. An action in which the user moves to the second point, the reception of a second received signal in the footwear 10, or the transmission of the payment request information in the footwear 10 is an example of “an acceptance step of accepting a payment request”.

When the payment request information is acquired, the shop communicator 320 (EX) transmits the acquired payment request information to the management apparatus 200 (step S602). Next, the second controller 216 of the management apparatus 200 confirms payment of a payment calculated in step S700 (step S702).

Specifically, the management apparatus 200 transmits a user ID and a settlement amount to a settlement server (not shown) and requests settlement. The settlement server performs the settlement using the user's electronic money, a credit card function, a bank account, or the like that is preset. For example, the management apparatus 200 transmits a settlement result acquired from the settlement server to the user. For example, when the settlement is impossible, the user pays cash to staff in the shop or performs a prescribed process. Thereby, the process of one routine of the present flowchart ends.

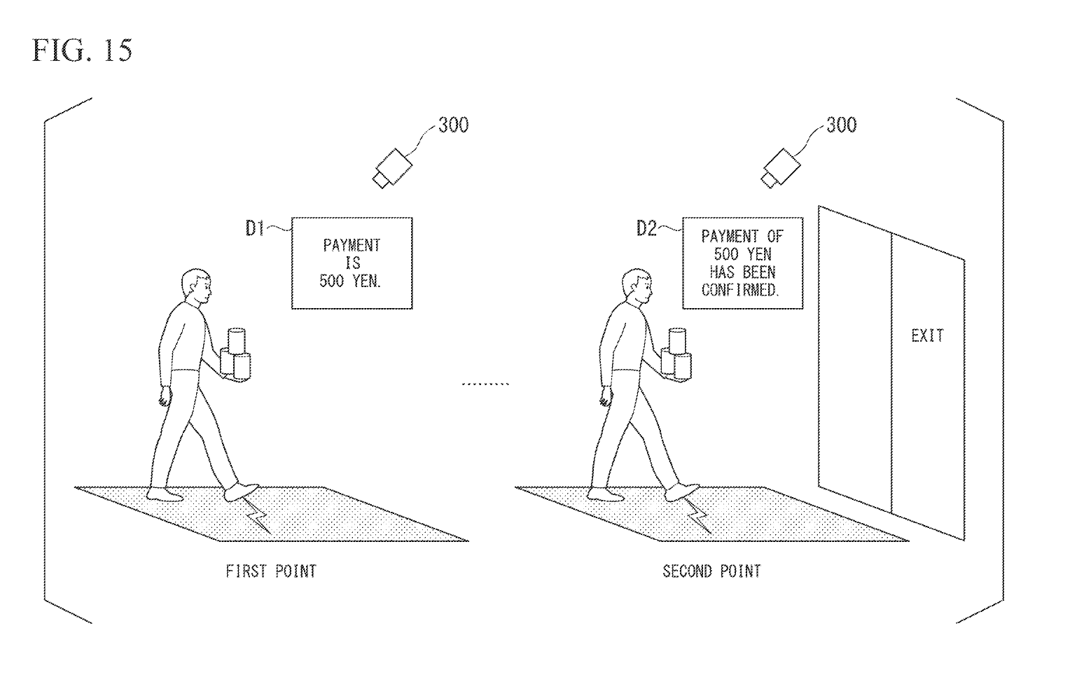

FIG. 15 is a diagram showing an example of appearances in which the user has stopped at the first point and the second point. For example, as shown in the left diagram of FIG. 15, when the user has stopped at the first point, the first controller 214 calculates a payment. For example, the first controller 214 transmits an image (payment related information) including the payment to a display D1 provided in the vicinity of the first point via the network NW and causes the image to be displayed.

For example, as shown in the right diagram of FIG. 15, when the user has stopped at the second point, the second controller 216 confirms the payment. For example, the second controller 216 transmits an image (payment related information) indicating that the payment has been confirmed, details, or the like to a display D2 provided near the second point via the network NW and causes the image to be displayed.

A payment or an amount of money to be paid may be displayed on the display D2 of the terminal apparatus 100. Also, when the management apparatus 200 has performed a process for calculating a payment or confirming payment, the management apparatus 200 may transmit information indicating that the process has been completed to the display D2 via the specific facility or the terminal apparatus 100 or directly without involving the specific facility or the terminal apparatus 100. When the information indicating that the process has been completed, details of the process (payment related information), or the like has been acquired, the footwear 10 notifies the user that the process has been completed using the informant. At this time, settlement information (for example, a payment or an amount of money to be paid) may be transmitted to a portable terminal or the like possessed by the user in consideration of the user's convenience or privacy. In this case, the footwear 10 or the portable terminal may be configured to provide a notification indicating that a settlement process has been performed.

According to the above-described process, the user can perform production or payment by wearing the footwear 10 and passing through a prescribed region. As a result, the user can perform economic activities more comfortably.

Although the process in which it is determined whether or not the user has arrived at the first point or the second point on the basis of a result of performing communication between the shop communicator 320 and the footwear 10 has been described above, a result of processing a captured image captured by the shop camera 300 or a detection result of the shop sensor 310 may be used in the above-described determination in place of (or in addition to) the process.

According to the above-described first embodiment, when the user wearing the footwear 10 is an authorized user, the footwear 10 can acquire a payment request of a reward for the user wearing the footwear 10 from the management apparatus 200, accept the acquired payment request in accordance with movement of the user to the second point, and transmit an acceptance result to the management apparatus 200 so that the user can perform economic activities more comfortably.

### Second Embodiment

Hereinafter, a second embodiment will be described. In the second embodiment, footwear communicates with a vehicle (a car, a motorcycle, or a light vehicle) and a residential facility. Differences from the first embodiment will be described below.

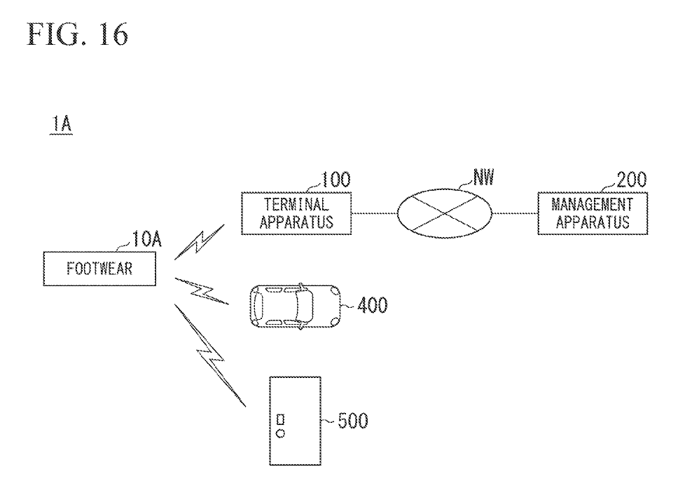

FIG. 16 is a diagram showing a configuration of an information processing system 1A of the second embodiment. In addition to the configuration of the first embodiment, the information processing system 1A further includes a vehicle 400 and a residential facility 500. The vehicle 400 communicates with a vehicle communicator 54 of footwear 10A and acquires a prescribed signal from the footwear 10A to unlock or lock a lock of a door or a trunk of the vehicle 400.

In the shown example, the residential facility 500 is a locking apparatus provided in a door of a house. The residential facility 500 includes a communicator, a controller, and a locker/unlocker. The communicator communicates with the footwear 10A. The controller controls the locker/unlocker. The locker/unlocker locks or unlocks the door under control of the controller. The residential facility 500 communicates with a residential communicator 56 of the footwear 10A to unlock or lock the door by acquiring a prescribed signal from the footwear 10A.

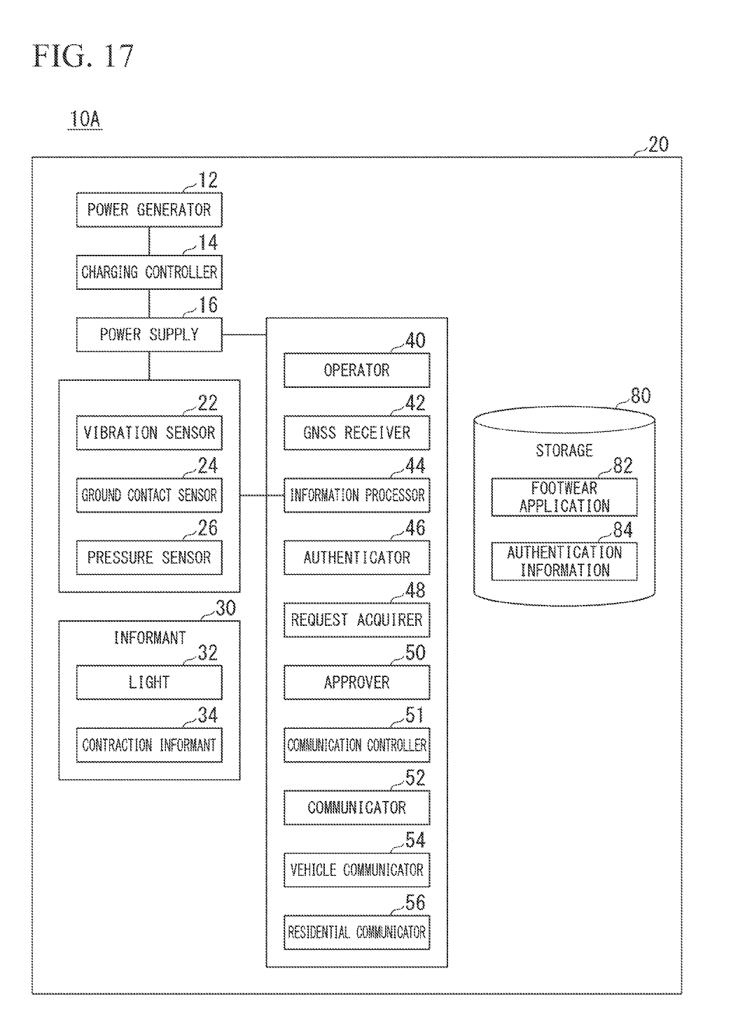

FIG. 17 is a diagram showing an example of a functional configuration of the footwear 10A. In addition to the functional configuration of the footwear 10 of the first embodiment, the footwear 10A further includes a communication controller 51, the vehicle communicator 54, and the residential communicator 56. The communication controller 51 controls the vehicle communicator 54 and the residential communicator 56. The vehicle communicator 54 communicates with the vehicle 400. For example, when a request signal is received from the vehicle 400, the vehicle communicator 54 transmits a prescribed signal for issuing an instruction for unlocking or locking the lock of the door or the trunk of the vehicle 400 to the vehicle 400 and causes the lock of the door of the vehicle 400 to be locked or unlocked. The residential communicator 56 communicates with the residential facility 500. For example, when a request signal has been received from the residential facility 500, the residential communicator 56 transmits a prescribed signal for issuing an instruction for unlocking or locking the door of the residential facility 500 to the residential facility 500 and instructs the residential facility 500 to unlock or lock the door of the residential facility 500.

According to the above-described second embodiment, the user can unlock and lock the lock when the footwear 10 communicates with a vehicle, a residential facility, or the like. As a result, the user's convenience is improved. Although the example in which door locks of the vehicle and the residential facility are controlled has been described above, instead of the example (or in addition to the example), prescribed control may be performed by starting an engine of a vehicle, starting a residential device, or performing communication with another apparatus or device (for example, an agricultural machine) or the like. Also, the footwear 10 may include a detection sensor for detecting a temperature of a foot of the user and the footwear 10 may cause a heater provided in a house or a vehicle to be operated when the temperature of the foot of the user is lower than or equal to a prescribed temperature.

### Third Embodiment

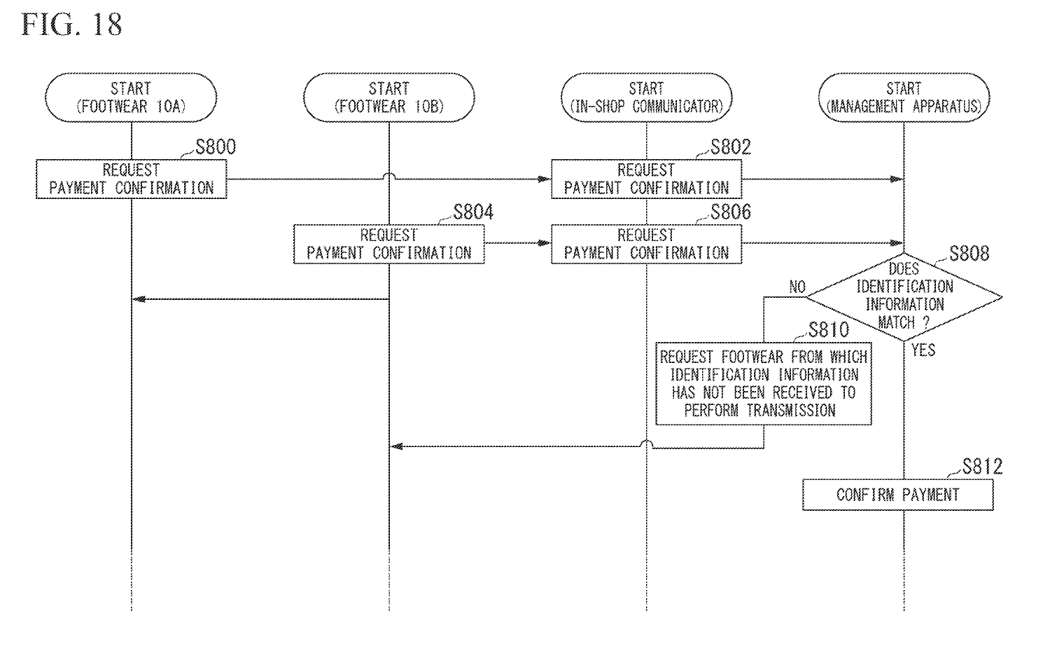

Hereinafter, a third embodiment will be described. An information processing system 1B according to the third embodiment includes footwear 10 (10A) and footwear 10B having a function equivalent to that of the footwear 10 (10A). Differences from the second embodiment will be described below. For example, it is assumed that the user wears the footwear 10A on a right foot and wears the footwear 10B on a left foot. FIG. 18 is a sequence diagram showing a process to be executed by the information processing system 1B of the third embodiment. The present process is a process to be executed when the user has arrived at a first point or a second point. That is, the present process is a process to be performed during payment calculation or settlement. Hereinafter, as an example, the present process will be described as being performed after the user arrives at the second point (after the processing of step S408).

When the user has arrived at the second point, the footwear 10A transmits payment request information (an example of “first information”) for requesting payment confirmation (settlement) to a shop communicator 320 (EX) if a second signal is received (step S800). When the payment request information is acquired, the shop communicator 320 (EX) transmits the acquired payment request information to a management apparatus 200 (step S802).

Also, when the user has arrived at the second point, the footwear 10B transmits payment request information (an example of “second information”) for requesting payment confirmation (settlement) to the shop communicator 320 (EX) if the second signal is received (step S804). When the payment request information is acquired, the shop communicator 320 (EX) transmits the acquired payment request information to the management apparatus 200 (step S806).

The second controller 216 of the management apparatus 200 determines whether or not the information transmitted in steps S802 and S806 matches a combination of identification information of the footwear 10A and identification information of the footwear 10B registered in advance (step S808). That is, the management apparatus 200 determines whether or not to execute a prescribed process on the basis of the first information and the second information.

When the identification information does not match the combination of the identification information or when the identification information has not been acquired from one piece of the footwear 10A and the footwear 10B, the management apparatus 200 requests the footwear 10 (which is a pair of footwear and) from which the identification information has not been acquired to transmit the identification information or notifies the user of information indicating that settlement cannot be performed (information indicating that the prescribed process is not being executed). For example, when the identification information has not been acquired from the footwear 10B, the management apparatus 200 requests the footwear 10B to transmit the identification information (step S810).

When the information transmitted in steps S802 and S806 matches the combination of the identification information of the footwear 10A and the identification information of the footwear 10B registered in advance, the second controller 216 of the management apparatus 200 confirms payment (step S812).

If the identification information does not match and settlement cannot be performed, the user may perform the settlement using another apparatus. The other apparatus is a terminal apparatus 100 or a shop apparatus provided in the shop. For example, the terminal apparatus 100 or the shop apparatus acquires information about the settlement from the management apparatus 200. The user performs a prescribed operation on the terminal apparatus 100 (for example, performs an operation such as an input of a password). The management apparatus 200 determines whether or not to execute a prescribed process on the basis of information (for example, a password or the like) acquired from another apparatus.

Also, the management apparatus 200 may generate purchase target lists 226 corresponding to the footwear 10A and the footwear 10B, perform settlement when the details of the two purchase target lists 226 match, and notify the user of information indicating that settlement is not possible when the details do not match (information indicating that the prescribed process is not being executed).

Also, in the process of FIG. 18 described above, the management apparatus 200 may confirm payment even when payment request information is acquired from the footwear 10A or 10B. Also, for example, when it is determined that the user has arrived at the second point from an image captured by a shop camera 300, the management apparatus 200 may perform settlement on the basis of the payment request information (the second information) acquired from the footwear 10B if it is not possible to acquire the payment request information from the footwear 10A (if it is not possible to perform communication with the footwear 10A).

According to the above-described third embodiment, because a prescribed process such as payment is executed on the basis of the information transmitted by the footwear of both feet, it is possible to limit the execution of a process unintended by the user.

### Modified Example of Third Embodiment

Hereinafter, a modified example of the third embodiment will be described. In the information processing system 1B of the modified example of the third embodiment, after the footwear 10B acquires a payment confirmation request from the footwear 10A, the footwear 10B requests the management apparatus 200 to confirm payment. Differences from the third embodiment will be described below.

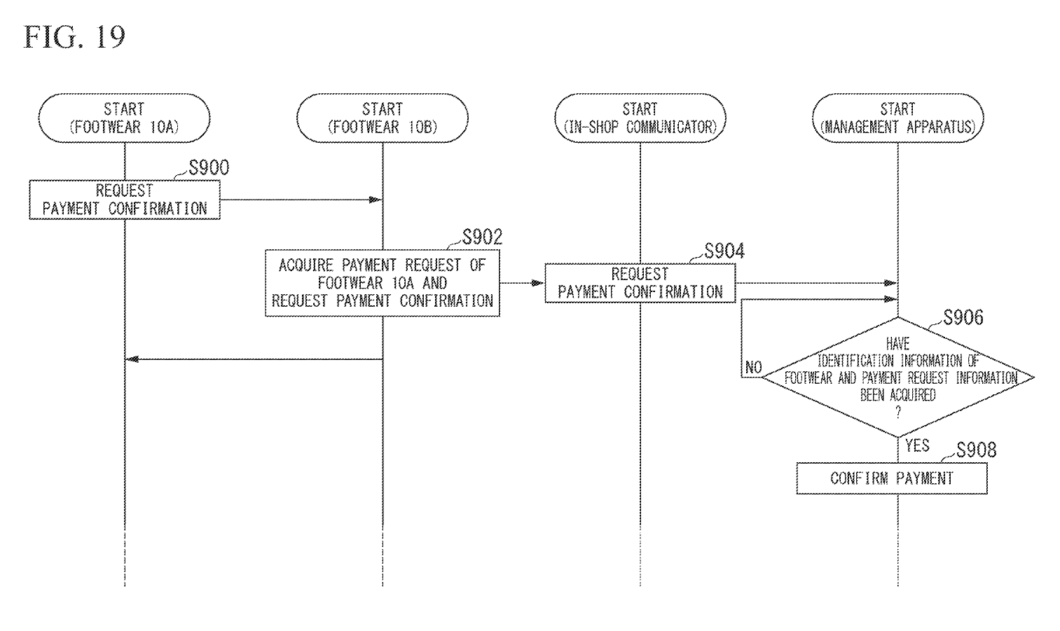

FIG. 19 is a sequence diagram showing a process to be executed by the information processing system 1B of the modified example of the third embodiment. Differences from the flowchart of FIG. 18 will be mainly described. When the user has arrived at the second point, the footwear 10A transmits the identification information of the footwear 10A and the payment request information for requesting payment confirmation (settlement) to the footwear 10B if the footwear 10A receives a second signal (step S900).

When the footwear 10B acquires the identification information of the footwear 10A and the payment request information from the footwear 10A after the second signal is received, the acquired identification information of the footwear 10A and the footwear 10B and the payment request information are transmitted to the shop communicator 320 (EX) (step S902). When the identification information of the footwear 10A and 10B and the payment request information is acquired, the shop communicator 320 (EX) transmits the acquired identification information of the footwear 10A and 10B and the payment request information to the management apparatus 200 (step S904).

The second controller 216 of the management apparatus 200 determines whether or not the identification information of the footwear 10A and 10B and the payment request information have been acquired (step S906). When the identification information of the footwear 10A and 10B and the payment request information have been acquired, the second controller 216 confirms payment of a calculated amount of money (step S908).

In the above-described modified example of the third embodiment, because one piece of footwear 10 executes a prescribed process such as payment by transmitting information transmitted by the other piece of footwear 10 and its own information to the management apparatus 200, it is possible to limit the execution of a process unintended by the user.

Although the example in which information transmitted from the footwear 10A and the footwear 10B is used when settlement is performed has been described in the third embodiment and the modified example of the third embodiment, the information transmitted from the footwear 10A and the footwear 10B may be used and an equivalent process may be executed even when another function is implemented (a different process is performed). Also, for example, a process may be performed using information transmitted from the footwear 10A and the footwear 10B for a first type of function and a process may be performed using information transmitted from the footwear 10A or the footwear 10B for a second type of function. Specifically, a process may be performed using information transmitted from the footwear 10A and the footwear 10B for a settlement function and a process may be performed using information transmitted from the footwear 10A or the footwear 10B for a function other than the settlement.

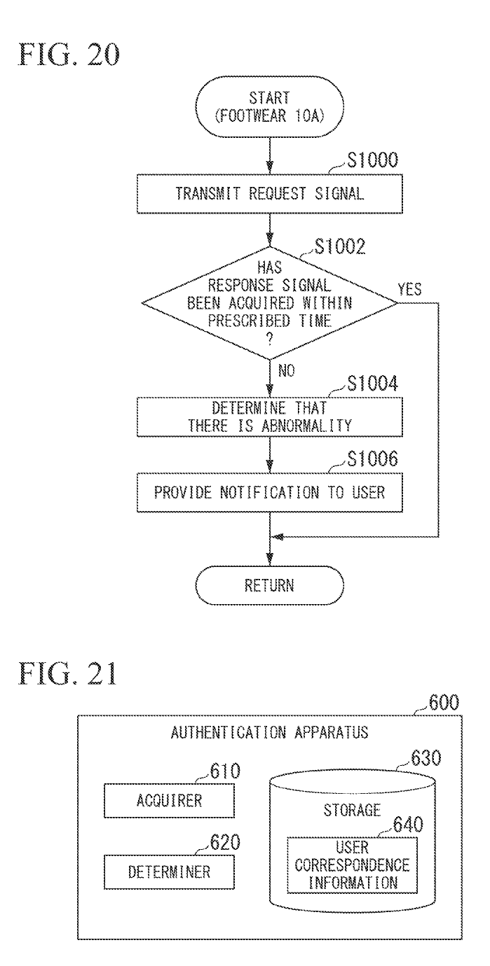

Also, the footwear 10A and the footwear 10B may detect a failure by communicating with each other. FIG. 20 is a diagram showing an example of a flow of a process to be executed by the footwear 10A or/and the footwear 10B. In the following description, it is assumed that the footwear 10A executes the process of FIG. 20.

First, the information processor 44 of the footwear 10A transmits a request signal to the footwear 10B (step S1000). For example, when the request signal has been acquired, the footwear 10B transmits a response signal to the footwear 10A. The footwear 10B may transmit information indicating an abnormality to the footwear 10A when there is an abnormality in a configuration, a function, or the like of the footwear 10B. Next, the footwear 10A determines whether or not the response signal has been acquired within a prescribed time after transmitting the request signal (step S1002).

When the response signal has been acquired within the prescribed time, a process of one routine of the present flowchart ends. When the response signal has not been acquired within the prescribed time, the footwear 10A determines that there is an abnormality (a failure or a power shortage) in the footwear 10B (step S1004) and notifies the user of information indicating the abnormality (S1006). Thereby, the process of one routine of the present flowchart ends.

As described above, it is possible to determine the abnormality of the footwear 10 on the basis of a result of determining whether or not the footwear 10A or the footwear 10B has acquired the response signal. As a result, the user can easily recognize the abnormality of the footwear 10.

Also, according to the above-described process, for example, when the footwear 10A between the footwear 10A and the footwear 10B has an abnormality, the footwear 10B may transmit instruction information for issuing an instruction for performing a prescribed process (for example, payment or the like) on the basis of information transmitted by the footwear 10B to an apparatus of a transmission destination. In this case, even when a determination is originally made on the basis of the information transmitted by the footwear 10A and the footwear 10B, the apparatus acquiring the instruction information may make the determination for the prescribed process on the basis of information transmitted from the footwear 10B (the second information).

Footwear 10 may include a part or all of the following functional configuration.

[1]

The authenticator 46 performs personal authentication of a first stage at a point in time at which the user has worn the footwear 10 and performs personal authentication of a second stage when locking or unlocking of a lock of the vehicle 400 or the residential facility 500 or settlement is performed. The personal authentication is authentication for identifying a user. For example, when a distribution of detection values of the pressure sensor 26 matches a preset distribution of detection values included in the authentication information 84, when a prescribed operation has been performed on the operator of the footwear 10, or when the footwear 10 has acquired information indicating that a prescribed operation has been performed on the terminal apparatus 100, it is determined that the personal authentication has succeeded. According to the above-described process, it is possible to reduce power consumption because it is unnecessary to continuously perform an authentication process.

Also, the personal authentication of the second stage is performed in response to a request signal from an infrastructure side. The infrastructure is, for example, a communicator provided within a shop, at an exit of a shop, or at a checkout point of a shop. Also, when the user wears the footwear 10, removes the footwear 10 once after the personal authentication of the first stage succeeds, and wears the footwear 10 again within a prescribed time, the personal authentication of the first stage may be omitted. In a case that foreign matter such as sand enters the footwear 10, the user remove footwear, eliminate the foreign matter. In this case authentication is iterated in wearing and removing of the footwear 10 for a short time. The authentication iterated is a complication. However the above-described process can avoid the iteration of authentication and improve convenience.

When an authentication result of the first stage is different from an authentication result of the second stage, the footwear 10, the terminal apparatus 100, or another terminal apparatus is notified of information indicating that the authentication results are different. Also, because a notification is issued if information based on the authentication process in the first stage is old or the user wearing the footwear 10 has changed for a short time when important authentication for the user in settlement or the like is required, security is improved.

Also, the user's foot information may be used for the above-described authentication. The foot information is one or more combinations of a detection result of the pressure sensor 26, a detection result of a detection sensor that detects a vein pattern provided in the footwear 10, or a detection result of a G sensor provided in the footwear 10. The G sensor is a triaxial acceleration sensor that detects accelerations in three directions of the footwear 10. The authenticator 46 compares a previously stored feature of a manner of walking of the user with the detection result of the G sensor, estimates him/she as a user (i.e., an authorized user) having a manner of walking having the same feature as that of the manner of walking of the user when a degree of matching is greater than or equal to a prescribed degree, and determines that authentication has succeeded. The feature of the manner of walking of the user is information indicating transition of acceleration until a prescribed time has elapsed when the acceleration changes from a state in which the acceleration is zero. Also, the authenticator 46 may determine whether or not authentication has succeeded on the basis of a method in which the user wears shoes. For example, the authenticator 46 authenticates the user on the basis of a pre-stored detection result of the G sensor when the user wears the shoes or a detection result of another sensor.

Power within the footwear 10 (power stored in the power supply 16) is used for the authentication of the first stage and power based on contact or contactless power feeding between the footwear 10 and the infrastructure side (for example, a power supply facility provided in a shop or the like) is used for the authentication of the second stage.

The contact or contactless power feeding is to supply power generated by electromagnetic induction to the footwear 10 or the terminal apparatus 100. The convenience can be improved because the authentication can be performed using a facility of the infrastructure side and the footwear 10 can reduce the power consumption further using the power of the infrastructure side.

When different authentication results are generated in the authentication of the first stage and the authentication of the second stage, a gesture of a foot in a state in which the prescribed footwear 10 is worn (load movement, foot position movement, tapping a floor surface with a foot in a prescribed rhythm (a foot stepping), or the like) is performed, authentication is determined to have succeeded. In other words, movement of the footwear 10 in a state in which the footwear 10 has been lifted above the ground is detected, the movement state of the footwear 10 is further detected, and a function or an application program according to the detection result is activated or enabled on the basis of the detection result.

The authenticator 46 compares detection results of the plurality of sensors 20, a detection result of the acceleration sensor (not shown), or the like with the authentication information 84 to determine whether or not a gesture of a foot has been performed. For example, the detection results of the plurality of sensors 20 when the gesture of the foot has been performed, the detection result of the acceleration sensor (not shown), and the like are pre-stored in the storage 80 as the authentication information 84.

Also, the footwear 10 may cooperate with the terminal apparatus 100 and determine whether or not authentication has succeeded. For example, the authenticator 46 may determine that authentication has succeeded on condition that position information of the footwear 10 and position information of the terminal apparatus 100 are within a prescribed distance or that communication has succeeded.

[2]

The footwear 10 can install various application programs acquired via the communicator 52. For example, the user can operate the terminal apparatus 100, cause the terminal apparatus 100 to communicate with the footwear 10, and cause various application programs to be stored in the storage 80. Also, the user can operate the operator 40 of the footwear 10, cause the footwear 10 to communicate with the network NW or another apparatus, and cause various application programs to be stored in the storage 80. The information processor 44 causes an acquired application program to be stored in the storage 80 or limits an operation of the application program on the basis of a user instruction or a preset condition.

The application program is, for example, an application for performing personal authentication, settlement, locking and unlocking of the lock of the vehicle 400 or the residential facility 500, an operation on another terminal apparatus according to a gesture of a foot, health management, or book data collection, a game application for causing walking or running motion or foot motion to be reflected in an operation or progress of a game, or the like. A health management application executes, for example, a process of deriving a health state of the user on the basis of a detection result of the sensor provided in the footwear 10 and transmitting the derivation result to the terminal apparatus 100. An application that performs an operation on another terminal apparatus by a gesture of a foot converts, for example, the detection result of the sensor provided in the footwear 10 into a prescribed operation on the other terminal apparatus and transmits information indicating details of the converted operation to other terminal apparatuses.

The footwear 10 performs wired communication or wireless communication with another apparatus and manages application programs or information stored in the storage 80. For example, the information processor 44 may manage the application programs or the information stored in the storage 80 automatically (for example, for every prescribed time) even when a prescribed operation by the user or an operation by the user is not performed. For example, the information processor 44 manually or automatically updates schedule information or the like to be used by the footwear 10. For example, when the footwear 10 is worn at a time other than a scheduled time when the footwear 10 is used in the schedule information, the function of the prescribed application is limited or the personal authentication may be set so that the personal authentication fails.

Thereby, it is possible to limit the operation of an application that is not required to be originally operated. Also, unintended settlement and unintended unlocking of the door of the vehicle 400 can be limited. For example, it is possible to eliminate a problem that settlement is performed only by going near the station or the door lock is unlocked only by passing in front of the car. Also, because it is possible to easily manage the application program and the like using the terminal apparatus 100 such as a smartphone, the user's convenience is improved.

Also, the above-described management is performed by the information processor 44 when the authentication by the authenticator 46 has succeeded and the above-described management by the information processor 44 may be limited or prohibited when authentication has failed. Because management is performed in a state in which personal authentication has succeeded, intervention by a malicious third party can be prevented and security can be improved.

When communication with another apparatus is performed and the function of the application program is expanded or when the application program is newly added to the footwear 10, a fee may be charged to the user wearing the footwear 10. For example, when a prescribed operation has been performed on the terminal apparatus 100 or the operator 40 of the footwear 10, a device for performing settlement for a charge charges a fee to the user. In this manner, an application program that implements necessary functions can be installed in the storage 80 of the footwear 10.

[3]

The footwear 10 may limit some or all of the electronic functions of its own apparatus when a state in which the vibration is small for a prescribed time continues (when a prescribed degree of vibration or more has not been detected). For example, the information processor 44 limits some or all of the electronic functions of its own apparatus when it is determined that vibration of a threshold value or less has continued for a prescribed time on the basis of a detection result of the vibration sensor 22. Thereby, power consumption can be limited. “When a prescribed degree of vibration or more has not been detected”, this indicates a state in which the user is not moving while wearing the footwear 10, for example, a state in which only a foot is being moved while the user sits on a chair. In this case, it is unnecessary to turn on the electronic function. It is also possible to detect the movement of the foot when the user is boarding or riding a car, a bicycle or the like and moving and turn off at least some of the electronic functions when the state thereof has been detected. In this case, for example, the footwear 10 can detect that the user is boarding or riding a car or a bicycle by comparing a detection result of the G sensor or the vibration sensor 22 or a detection result of the pressure sensor 26 or the like pre-stored when the user boards or rides a car or a bicycle with a detection result of the G sensor or the vibration sensor 22 or a detection result of the pressure sensor 26 actually detected.

Also, when the vibration of the threshold value or less has continued for a prescribed time, the information processor 44 may or may not limit a personal authentication function, a settlement function, a function of locking (unlocking) the lock of the vehicle 400, and a function of locking (unlocking) the lock of the residential facility 500. Also, the information processor 44 may change a prescribed time that is a criterion for starting to limit a personal authentication function, a settlement function, a function of locking (unlocking) the lock of the vehicle 400, or a function of locking (unlocking) the lock of the residential facility 500 for each function. For example, the prescribed time that is the criterion for starting to limit a personal authentication function, a settlement function, a function of locking (unlocking) the lock of the vehicle 400, or a function of locking (unlocking) the lock of the residential facility 500 may be shorter than a prescribed time that is a criterion for starting to limit another electronic function or may change on the basis of the user's setting. In this manner, it is possible to further limit power consumption by limiting functions that are not important and functions that are not frequently used without limiting functions that are important for the user and functions that are frequently used in everyday life.

For example, in a state in which the user wears the footwear 10 or when the user wears the footwear 10, the information processor 44 may output information for prompting the user to perform power generation or charging to the informant 30 or the terminal apparatus 100 if an amount of power stored in the power supply 16 is less than a standard. Thereby, the user can positively perform power generation, charging, or the like before the power stored in the power supply 16 runs out.

Also, the information processor 44 may cause information for prompting the user to perform power generation or charging to be displayed on the infrastructure side (for example, a display that is provided in a house, a shop, or a street and can communicate with the footwear 10 or the terminal apparatus 100 or the like). Also, the infrastructure-side apparatus can cause the terminal apparatus 100 or the infrastructure side to display information indicating that a failure has occurred in the footwear 10, information indicating the remaining amount of power stored in the power supply 16 or a degree of deterioration thereof, or information indicating that a signal to be transmitted from the footwear 10 cannot be received. Thereby, even if a problem occurs in the footwear 10 or when power stored in the footwear 10 is insufficient, the state of the footwear 10 can be ascertained via another apparatus.

[4]

When the personal authentication is performed by wearing the footwear 10, the feedback of an authentication result based on vibration, sound, light, or contraction of the footwear 10 may be provided to the user. That is, the authenticator 46 causes the informant 30 to issue a notification of the authentication result. For example, because it is possible to feed back the fact that the personal authentication is correctly performed or that the personal authentication is erroneously performed to the user when the personal authentication is performed, the user can easily recognize the authentication result.

[5]

When the personal authentication is performed by the footwear 10, the terminal apparatus 100, or the like and the locking (unlocking) of the vehicle 400, the residential facility 500, or the like or settlement is performed, the footwear 10, the terminal apparatus 100, the vehicle 400, or the residential facility 500 automatically transmits a processing result to a prescribed apparatus. By transferring a personal authentication result, the user or the manager can freely check and manage who has performed what type of processing (personal authentication/settlement) when and where using a prescribed apparatus at any time.

[6]

For example, the footwear 10 may be provided with a throttle for inserting a storage medium (for example, an SD card or the like) in which prescribed information is stored. The authenticator 46 may cause the authentication to succeed when the authentication information 84 matches the information stored in the storage medium inserted into the throttle. More reliable personal authentication can be implemented using a relatively inexpensive and lightweight storage medium.

[7]

An authentication code used for personal authentication is transmitted to the footwear 10 by inputting an ID or a password to an external device (such as the terminal apparatus 100). Then, the authenticator 46 of the footwear 10 compares the acquired personal authentication code with the authentication information 84 including the personal authentication code pre-stored in the storage 80 and determines whether or not authentication has succeeded. As a result, more reliable personal authentication can be implemented.

[8]

When the user wears the footwear 10, the authenticator 46 executes personal authentication and thereafter cancels the personal authentication when the footwear 10 has been removed or when a prescribed time has elapsed after removal of the footwear 10. Then, when the user has worn the footwear 10 again, the authenticator 46 performs the personal authentication. In this manner, because the personal authentication is performed again for the user removing the footwear 10, it is possible to limit a risk of malicious use by another person even if a function is inadvertently maintained as it is.

[9]

One or both of the pressure sensor 26 and the G sensor for detecting the acceleration of the footwear 10 are mounted inside the footwear 10. The information processor 44 locks or unlocks the lock of the door of the vehicle 400 pre-registered as a cooperative vehicle 400 (or the residential facility 500) or the like on the basis of one or both of the detection result of the pressure sensor 26 and the detection result of the G sensor. For example, the information processor 44 locks or unlocks the above-described lock of the door when it is detected that an action of lifting the footwear 10 above the ground has been performed on the basis of the detection result of the pressure sensor 26 and the detection result of the G sensor and the action information pre-stored in the storage 80. The action information is information including the detection result of the pressure sensor 26 and the detection result of the G sensor when the user has performed the action of lifting the footwear 10 above the ground. According to the above-described process, it is possible to operate the door from a long distance and the user's convenience is improved.

[10]

For example, an integrated circuit (IC) chip is mounted between a heel portion with relatively small bending at the bottom of the footwear 10 and a position just under an ankle of a user wearing the footwear 10. The IC chip implements the electronic function (for example, the information processor 44, the authenticator 46, or the like) of the footwear 10. Delivery in a state in which an IC chip is mounted with durability by concentrating functions on a relatively thick part with small bending in the footwear 10 is facilitated.

[11]

For example, a floor surface communicator for outputting a pass authentication signal is provided on a prescribed floor surface. When the footwear 10 has arrived at the prescribed floor surface, the footwear 10 communicates with the floor surface communicator. An authentication apparatus communicating with the floor surface communicator determines whether or not authentication has succeeded on the basis of a communication result between the footwear 10 and the floor surface communicator.

When the authentication has succeeded, the authentication apparatus performs control so that a light provided on the floor surface in a traveling direction of the user is turned on or off. In this case, the user can enter a prescribed building, a train station, a theme park, or the like. Also, when the authentication has failed, the authentication apparatus may cause a display or a speaker to output information indicating that authentication has failed to the user. Even without using a ticket gate machine, it is possible to perform authentication related to the passage of the user wearing the footwear 10.

[12]

In the footwear 10, the IC chip is mounted at a position of an arch that is least loaded when a user wearing the footwear 10 walks. Thereby, it is possible to implement high durability against abrasion or impact of the footwear 10 for a long period of time.

[13]

The footwear 10 and the other footwear 10 may be treated as a set (a pair). The other footwear 10 has a functional configuration similar to that of the footwear 10. Also, the footwear 10 and the other footwear 10 transmit and receive information in communication to and from each other via the communicator 52. For example, when the authentication apparatus has failed in authentication, the authentication apparatus communicates with the other footwear 10 to cause authentication of the user to be executed. A function permitted after the success of the authentication is turned on when the authenticator 46 of the other footwear 10 has succeeded in the authentication and the authenticator 46 causes the footwear 10 to execute the authentication again if the authentication has failed. In this manner, the footwear 10 and the other footwear 10 alternately perform the authentication process until the authentication has succeeded, thereby providing redundancy for authentication. Also, it is unnecessary to return to a position where communication with the floor surface communicator can be performed again or repeat a foot stepping in a place thereof by temporarily moving to a position away from the floor surface communicator when the authentication has not succeeded and the user's convenience is improved.

[14]

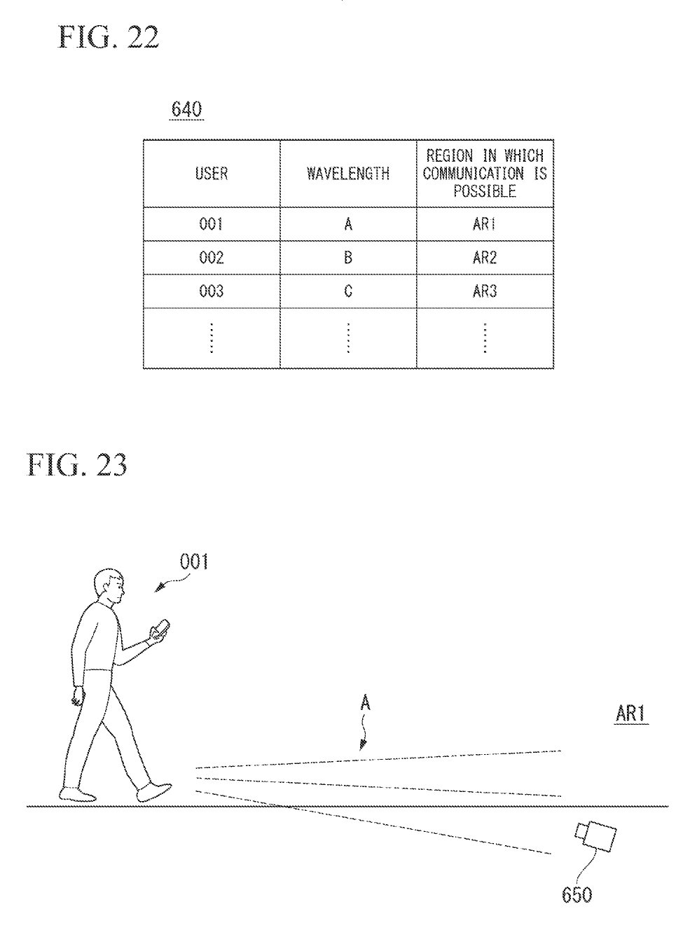

The authentication apparatus may determine whether or not the user can pass through a prescribed region on the basis of invisible light (for example, infrared light) of a specific wavelength band radiated from the footwear 10. FIG. 21 is a diagram showing an example showing a functional configuration of the authentication apparatus 600. The authentication apparatus 600 includes an acquirer 610, a determiner 620, and a storage 630. The acquirer 610 acquires information about the wavelength from the camera 650 (see FIG. 23). The information about the wavelength is information about the wavelength (information indicating a distribution of wavelengths, for example) included in an image captured by the camera 650. The camera 650 is, for example, a multispectral camera capable of analyzing a wavelength included in a captured image. The determiner 620 determines whether or not the user can pass through a prescribed region on the basis of user correspondence information 640 stored in the storage 630 and information acquired by the acquirer 610. FIG. 22 is a diagram showing an example of details of the user correspondence information 640. The user correspondence information 640 is information in which identification information of the user, a wavelength, and information indicating a region where passage is possible are associated with one another.

For example, when the wavelength extracted from the image captured in the prescribed region is associated as a wavelength capable of passing through the prescribed region in the user correspondence information 640, the determiner 620 permits the passage of the user radiating the wavelength.

FIG. 23 is a diagram showing an authentication process performed by the authentication apparatus 600. For example, when a user 001 wears the footwear 10 and attempts to pass through a region AR1, the footwear 10 radiates invisible light of wavelength A from a radiator mounted on the footwear 10. For example, when a prescribed signal provided on a floor surface is received, invisible light of wavelength A is radiated for a prescribed time. One or more cameras 650 are provided at a position where invisible light emitted by the footwear 10 can be imaged such as a floor surface. The camera 650 images invisible light, derives a distribution of wavelengths from the captured image, and transmits a derivation result and information indicating a region where its own apparatus is provided to the authentication apparatus 600 using wired or wireless communication.

Then, the determiner 620 of the authentication apparatus 600 determines whether or not the user can pass through a prescribed region on the basis of the derivation result and the user correspondence information 640. When it is determined that the user cannot pass through the prescribed region, the determiner 620 causes an outputter provided near the prescribed region to output information indicating that passage is not possible or controls a gate in a closed state if the gate is provided in the prescribed region.

Although the example in which a wavelength is identified has been described above, a determination of the passage may be made using a spectrum or a technique of identifying a feature quantity of a person in place of (or in addition to) the wavelength. As described above, it is possible to promptly determine the passage of a plurality of users while limiting a capital investment amount using a result of recognizing the image captured by the camera 650.

For example, if the authentication apparatus communicates with an IC tag and determines whether or not permit passage through a prescribed region in an environment in which a plurality of people (from several people to several dozens of people) pass through a prescribed region simultaneously and asynchronously (for example, a ticket gate of a crowded station or the like), a communication distance is at most 70 mm (a “nearby type” in which communication up to the longest distance in a contactless manner is possible is assumed) even if an authentication apparatus or a gate includes an IC tag corresponding to anti-collision and a reader and it is ultimately necessary to install an in-floor antenna at each gate in order to recognize IC tags of footwear of all users.

On the other hand, in the case of image recognition using the camera 650, simultaneous monitoring a region of a wide range and a plurality of users included within a photographing region is possible and it is possible to simultaneously make determinations for a plurality of users. Furthermore, in determining whether the user is allowed to pass through a prescribed region, it is only necessary to deal with two classes of “permission and denial”, for example, so that passage through a prescribed region (or gate) for wavelength A is permitted and passage through a region other than the prescribed region is not permitted, instead of multiple classes belonging to a user ID. Thus, the above-described process is implemented by the footwear 10 side radiating light of a wavelength of either of the two classes instead of installing a plurality of in-floor antennas purposely.

Also, although it is difficult to individually assign a unique wavelength band of invisible light to each of several hundreds to thousands of user IDs, assignment is possible without problem and identification is possible if there are two types of wavelength bands of “permission/denial”. Furthermore, even when there are three or more classes of wavelength bands such as “A gate permission, B gate permission, A and B gate permission, and denial”, it is possible to assign a wavelength band that can be identified.

By making a determination of whether or not it is possible to pass through a prescribed region according to the above-described configuration, a facility such as an in-floor antenna facility becomes unnecessary for each region (gate) and a cost can be reduced. Also, by replacing a personal authentication problem with a gate passage permission/denial authentication problem, it is possible to reduce the number of classes to be authenticated. Also, as long as a determination problem of at most several classes is implemented, implementation is possible also in a multispectral recognition system. Furthermore, in the case of a recognition system using a camera, unlike the in-floor antenna, it is possible to simultaneously recognize a plurality of people and implementation by a small number of cameras is possible. As a result, there is a cost merit from the viewpoint of capital investment by employing the above-described system.

[15]

Damage is prevented by disposing an IC chip in an upper portion of the footwear 10 where pressure is not applied during walking. Because pressure is not applied during normal use (during walking), the damage of the IC chip and a substrate is prevented.

[16]

When the authentication of the user has failed, the authenticator 46 controls an electronic magnet disposed in the bottom of the footwear 10 (the other footwear 10) in an ON state, causes the footwear 10 and the other footwear 10 to be engaged with each other, and limits the use of the footwear 10. Even if the theft occurs due to removal of the footwear 10, security is improved because a thief cannot use or wear the footwear 10.

[17]

The footwear 10 or the terminal apparatus 100 may output an alarm to a prescribed outputter or issue a notification to a prescribed terminal apparatus (for example, a terminal apparatus managed by a legal agency) when a prescribed condition has been satisfied. The prescribed condition is that the footwear 10 is present at a position that is other than the user's home and is at a specific distance from a position where the terminal apparatus 100 is present when the footwear 10 and the terminal apparatus 100 has immediately previously communicated with each other. Even if the theft occurs due to the removal of the footwear, security is improved because the removed footwear 10 can be easily discovered or reported.

[18]

A conductor constituting the communicator 31 may be wound around the circumference of the footwear 10 or a circumference portion of the footwear 10. Thereby, it is possible to create a magnetic flux in a wide range. For example, it is possible to more reliably perform communication with the floor surface communicator, and it is possible to limit the occurrence of communication errors.

[19]

The footwear 10 may have a function of charging the footwear 10 with electronic money. For example, when public transportation (for example, a station) is used, the footwear 10 communicates with a ticket gate machine provided near a ticket gate of the station. The ticket gate machine permits the user to enter the station if the amount of electronic money with which the footwear 10 is charged is greater than or equal to a reference amount of money and does not permit the user to enter the station if the amount of electronic money with which the footwear 10 is charged is less than the reference amount of money. When the entrance of the user is not permitted, the ticket gate machine causes a display provided in the ticket gate machine or near the ticket gate machine to display the fact that the electronic money with which the footwear 10 is charged is insufficient or causes a light to be turned on.

Although the example of the ticket gate machine has been described above, another apparatus that communicates with the footwear 10 and determines the permission of passage of the user wearing the footwear 10 or the like may be used in place of (in addition to) the example. Also, a notification of a result of determining the permission of passage or the like may be provided by operating the informant of the footwear 10 or provided to the terminal apparatus 100 of the user.

According to the above-described process, it is possible to shorten a movement time of the user when public transportation is used. Furthermore, because the determination of passage or the like is promptly performed, congestion is eliminated.

[20]

Equivalent functions may be mounted on the footwear 10 for the right foot and the footwear 10 for the left foot. Also, the left and right footwear 10 is equipped with a failure detector for detecting a failure of each function of the footwear 10. For example, when a failure is detected by the failure detector, the information processor 44 of the footwear 10 from which the failure has been detected stops the function of the footwear 10 and transmits information indicating that the failure has occurred to the footwear 10 that is operating normally. Furthermore, the information processor 44 of the footwear 10 that is operating normally notifies the user of the information indicating that the footwear 10 in which the failure has been detected has failed using the function of the footwear 10 that is operating normally (by vibration, sound, or the like). In this manner, redundancy of the information processing system 1 can be implemented, and it is possible to limit the user's inconvenience. As a result, it is possible to provide the user with a system with high reliability and a system with security.

[21]

The footwear 10 may include an odor sensor to detect an odor. In this case, information indicating the odor associated with the user is stored in the storage 80 as the authentication information 84. The information processor 44 may authenticate the user further on the basis of the information indicating the odor and the authentication information 84 which is the information indicating the odor in addition to (or in place of) authentication using a detection result of the pressure sensor 26 or the like. Also, the information processor 44 may notify the user when a detection result of the odor sensor is a prescribed detection result. By mounting the odor sensor on the footwear 10, it is possible to improve the reliability of personal authentication or to guide the user to perform maintenance when a malodor is detected.

Although the example in which the footwear 10 implements each function has been described in each of the above-described embodiments, an embedded or attached electronic device may implement each function instead of the footwear 10. For example, the process described in each embodiment and the like may be implemented by an insole in which the electronic device is mounted or an electronic device attached to a prescribed place (for example, a shoelace or a heel portion) of the footwear. That is, a part or all of the configuration included in the footwear 10 may be mounted in the insole, an electronic device attached to a prescribed position of the footwear, or the like.

### [Hardware Configuration]

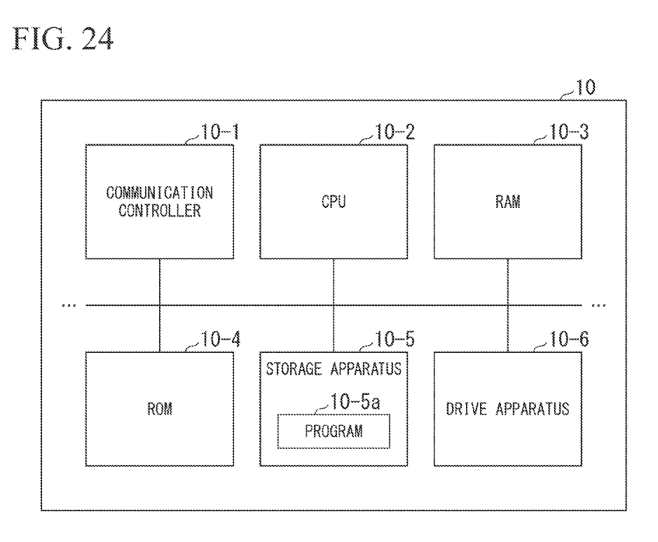

FIG. 24 is a diagram showing an example of a hardware configuration of the electronic device embedded in or attached to the footwear 10 of the embodiment. As shown, the electronic device embedded in or attached to the footwear 10 includes a communication controller 10-1, a CPU 10-2, a random access memory (RAM) 10-3 used as a working memory, a read only memory (ROM) 10-4 storing a boot program and the like, a storage apparatus 10-5 such as a flash memory or a hard disk drive (HDD), a drive apparatus 10-6, and the like are interconnected via an internal bus or a dedicated communication line. The communication controller 10-1 communicates with components other than the electronic device embedded in or attached to the footwear 10. A program 10-5a to be executed by the CPU 10-2 is stored in the storage apparatus 10-5.

This program is loaded to the RAM 10-3 by a direct memory access (DMA) controller (not shown) or the like and executed by the CPU 10-2. Thereby, some or all of the information processor 44, the authenticator 46, the request acquirer 48, and the approver 50 are implemented.

The above-described embodiment can be represented as follows.

An electronic device mounted on a footwear, the electronic device including:

a storage apparatus storing a program; and

a hardware processor,

wherein the hardware processor executes a program stored in the storage apparatus, so that the electronic device that is embedded in or attached to the footwear and has a communicator for communicating with an external terminal

authenticates whether or not a user wearing the footwear is an authorized user,

acquires at least a payment request of a reward for a user wearing the footwear from the external terminal via the communicator when the authentication has succeeded,

accepts the acquired payment request in accordance with a prescribed action performed by the user, and

transmits an acceptance result to the external terminal via the communicator,

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information processing method in which an electronic device embedded in footwear or attached to the footwear and having a communicator configured to communicate with one or more external terminals executes:
an authentication step of authenticating whether or not a user wearing the footwear is an authorized user;
an acquisition step of acquiring at least a payment request of a reward for the user wearing the footwear from the one or more external terminals via the communicator when the authentication has succeeded;
an acceptance step of accepting the acquired payment request in accordance with a prescribed action performed by the user; and
a transmission step of transmitting an acceptance result to the one or more external terminals via the communicator.

2. The information processing method according to claim 1, wherein the prescribed action of the user is movement of the user to a prescribed position.

3. The information processing method according to claim 1,
wherein the electronic device is configured to determine that the acquired payment request has been accepted when the user has performed the prescribed action in the acceptance step.

4. The information processing method according to claim 3, wherein the electronic device is configured to transmit payment related information to a terminal apparatus, which is capable of being visually recognized by the user, after processing of the transmission step.

5. The information processing method according to claim 1, wherein the electronic device is configured to further execute a notification step of issuing a notification indicating that the acceptance has been made to an informant provided in the footwear after the acceptance for the payment request is made.

6. The information processing method according to claim 5,
wherein the informant is a conductive actuator that contracts with electric current application or a change in temperature due to electric current application, and
wherein the electronic device is configured to issue the notification by delivering a tactile change to a foot of the user in contact with the footwear by operating the actuator in the notification step.

7. The information processing method according to claim 1, wherein, after the user is authenticated to be the authorized user in the authentication step, the electronic device is configured to cancel the authentication when the user removes the footwear or when a prescribed time has elapsed after the removal.

8. The information processing method according to claim 1,
wherein the electronic device is configured to detect vibration occurring in the footwear, and
wherein the electronic device is configured to control some or all of electronic functions provided in the footwear in an OFF state when vibration of a prescribed level or more has not been detected.

9. The information processing method according to claim 1,
wherein the footwear or the electronic device for which the user has been authenticated to be the authorized user in the authentication step is configured to radiate light including identification information, and
wherein a management apparatus is configured to acquire the identification information included in the radiated light and make a prescribed determination on the basis of the acquired identification information included in the light.

10. The information processing method according to claim 1,
wherein an electromagnet is provided in the footwear, and
wherein the electronic device is configured to control the electromagnet in an ON state on the basis of a result of authenticating whether or not the user is the authorized user in the authentication step or on the basis of information transmitted by an external terminal.

11. The information processing method according to claim 1, wherein the electronic device is configured to limit some or all of electronic functions executable by the footwear on the basis of an operation of an operator provided in the footwear performed by the user or on the basis of an instruction from an external terminal.

12. The information processing method according to claim 1, wherein the electronic device is configured to detect movement in a state in which the footwear has been lifted above the ground and detect a movement form of the footwear and cause a function according to a detection result to be activated or enabled on the basis of a detection result.

13. An information processing method comprising:
transmitting, by an electronic device embedded in first footwear or attached to the first footwear and having a communicator configured to communicate with an external terminal, first information for accepting a payment request to a management apparatus;
transmitting, by an electronic device embedded in second footwear or attached to the second footwear and having a communicator configured to communicate with an external terminal, second information for accepting a payment request to the management apparatus; and
determining, by the management apparatus, whether or not to execute a prescribed process on the basis of the first information and the second information.

14. The information processing method according to claim 13, wherein the management apparatus is configured to notify a user of information indicating that the prescribed process is not being executed if the management apparatus determine not to execute the prescribed process.

15. The information processing method according to claim 13, wherein the management apparatus is configured to determine whether or not to execute the prescribed process on the basis of information acquired from another apparatus if management apparatus determine not to execute the prescribed process.

16. The information processing method according to claim 13, wherein the management apparatus is configured to determine whether or not to execute a process different from the prescribed process on the basis of the first information without using the second information.

17. An information processing method comprising:
determining, by a management apparatus, which acquires first information transmitted by an electronic device embedded in first footwear or attached to the first footwear and having a communicator configured to communicate with an external terminal or second information transmitted by an electronic device embedded in second footwear or attached to the second footwear and having a communicator configured to communicate with an external terminal, whether or not to execute a prescribed process on the basis of the second information when communication with the first footwear is not possible or when acquisition of the first information is not possible.

18. The information processing method according to claim 13, wherein the first footwear is footwear for a right foot and the second footwear is footwear for a left foot or the first footwear is footwear for a left foot and the second footwear is footwear for a right foot.

19. The information processing method according to claim 13, wherein the prescribed process is a process on payment of a reward.
